(19) United States
(12) Patent Application Publication
(10) Pub. No.: US 2012/0261256 A1
(43) Pub. Date: Oct. 18, 2012

(54) SAMPLE HOLDERS AND ANALYTICAL INSTRUMENT FOR POINT-OF-CARE QUALIFICATION OF CLINICAL SAMPLES

(76) Inventors: Chia-Pin CHANG, Singapore (SG); David J. Nagel, Falls Church, VA (US)

(21) Appl. No.: 13/402,592

(22) Filed: Feb. 22, 2012

Related U.S. Application Data
(60) Provisional application No. 61/474,952, filed on Apr. 13, 2011.

(51) Int. Cl. B01L 3/00; G01N 21/59; G01N 27/26; G01N 21/76; G01N 27/00; G01N 21/75; G01N 21/64

(52) U.S. Cl. 204/400; 422/547; 422/82.05; 422/82.09; 422/82.08; 422/52; 422/82.01; 422/82.02

(57) ABSTRACT

This invention has two synergistic elements for simultaneous use in point-of-care or field analyses of diverse substances important to clinical medicine and other applications. The first element is a sample holder in which are stored the several reagents need for quantification of target molecules. The onboard storage of reagents in a water soluble plastic obviates the need for purchase, storage, measuring and mixing of the required reagents prior to analyses. The second part of the invention is a compact hand-held analyzer made of modern miniature optical components, into which the holder is inserted right after it is loaded with a sample by capillary action. The combination of the holder and analyzer permits analyses that are ten times faster than those done with current analyzers, and equally accurate. Analyses can be performed by diverse people, who require only a few minutes of training in the use of the entire invention.

### RELATED APPLICATIONS

This application claims the benefit of U.S. Provisional Application No. 61/474,952, filed Apr. 13, 2011, the entire contents of which are incorporated herein by reference.

The present invention also makes reference to the following documents, all of which are incorporated herein by reference in their entireties and are referred to in the provisional application: Chia-Pin Chang entitled “Design, Development and Testing of a Fluorescence-Based Microfluidics System for Uric Acid Analysis of Clinical Samples”; Chia-Pin Chang, et al., “Compact Optical Microfluidic Uric Acid Analysis System” Biosensors and Bioelectronics, 26 (10), 4155-4161, 2011; Chia-Pin Chang, et al., “Computational Methodology for Absolute Calibration Curves for Microfluidic Optical Analyses,” Sensors, Vol. 10, pages 6730-6750, Jul. 12, 2010; and Chia-Pin Chang et al., “Irradiance Dependence of Photobleaching of Resurofin,” Journal of Photochemistry and Photobiology A: Chemistry, Volume 217, pages 430-432, Nov. 23, 2010.

### BACKGROUND OF THE INVENTION

Clinical medicine involves two major activities, diagnoses and treatments. Proper therapeutics, which range from mediations to surgeries, depend on having appropriate, correct and timely diagnostic information.

There are two ways to measure the concentration (molecules per volume element) in a complex sample. The first is to separate the materials present in the sample in space and time by means of filtration and other processes, notably chromatography. The second approach does not require separations, but must involve some chemical means of “recognizing” the analytical target molecules in the presence of many other molecules and, often, particles. The analysis of glucose in blood is a common example. There must be some molecules in the sample holder, placed into an analytical instrument, which will respond only to the target molecules, such as glucose. Also, the molecular recognitions must be transduced into some measurable optical or electronic signal for display or recording.

Commercial glucose meters are cheap, portable, fast and generally accurate. However, both sampling technologies and analytical instruments for many other clinically important molecules are expensive, large and fixed in position, slow and require a trained operator to handle the required reagents and operate the system. Instruments used for blood analyses can cost over $200,000 and are the size of a desk. They can quantify the concentration of many different molecules. Table top instruments the size of an office printer usually cost over $10,000. They can be located near the point-of-care in some cases, but cannot be used outdoors as is necessary for health care in third world countries. Such instruments can be lifted by one person but are not portable in the usual sense. And, they require electrical power, that is, they are not battery operated. Importantly, those instruments are commonly made to analyze for only one substance of clinical interest, for example uric acid. In the case of both the large, central laboratory instruments and the table top instruments, the sample has to be brought to the analyzer. This requires labeling and accounting for the sample, requires trained personnel to handle samples and transfer part of them into sample holders, takes time (sometimes days) and costs money. Also, the large instruments do not make optimum use of photons emitted by a light source, which makes them less light and energy efficient. That is, they cannot use low power light sources that run cooler and require less electrical power than the current analyzers.

### SUMMARY OF THE INVENTION

The present invention advances the ability to provide therapeutic information at the point-of-care, such a doctor's office or a hospital room. It also provides the basis for more cost effective analyses for clinically important molecules, with uric acid as a prime example. The invention can be used by ordinary medical personnel with only a few minutes of training. The resulting information will be comparable to that from large and expensive central laboratory equipments, which require a highly-trained operator. The cost per analysis is expected to be about 20% or less of the cost for use of current analytical equipment.

The invention includes of a disposable thin sample holder and an analytical instrument. The sample holder is distinguished by having all the chemicals required for an analysis stored within it during its manufacture. This eliminates the need for multiple bottles of reagents, and the time and equipment needed for their mixing prior to an analysis. Even if the dispensation of those chemicals and their handling is done by a machine, the reagent bottles still have to be bought, stored properly and put in place within a metering and mixing machine, which is a complex assemblage of tubes, pumps and other components. The chemicals stored within the holder are inside of a water-soluble polymer. This protects them and preserves their viability. The polymer dissolves upon sample insertion, freeing the reagent molecules, which quickly mix with the sample by diffusion. With this invention, the user has only to open the sealed envelope containing the holder, insert the sample, place the holder into the instrument also disclosed here, and push the start button on the instrument. The quantitative analysis is accomplished automatically and the answer is immediately available on a display or sent by wireless means to a personal computer. The procedure takes only a few minutes. This contrasts with analysis times of half an hour or more in the large current instruments, not counting time for sample transfer to a laboratory, nor the time and expense of accounting for samples.

A summary of other advantages of the new sample holder included the following points. Small samples, less than one or two drops, are sufficient due to the thin nature of the holder. There is no need for pre-concentration, separations or sample mixing. Loading of the sample into the holder exploits natural capillary action without the need for pumps. The holder has been shown in tests to provide a very good signal-to-noise performance. The thin character of the holder permits the use of samples, notably blood, that are too opaque for use in conventional cuvettes. It also reduces photobleaching of the sample and reagent materials. Diverse means can be used to obtain analytical specificity using the holder, including enzymes, DNA, RNA, antibodies, aptamers and other recognition molecules, with enzymes the preferred approach. The holder also permits use of a wide variety of transduction methods that enable the measurement of signals dependent on the prior recognition step. Optical fluorescence is a preferred approach to transduction.

The sample holder is very adaptable. It has been effectively demonstrated for analysis of uric acid. High levels of uric acid in the body can lead to gout and pre-eclampsia. They also appear during chemotherapy, due to tumor lysis, and be life threatening on the time scale of hours. There are tens of millions of patients in the world that are candidates for uric acid analysis, if appropriate commercial analyzers for that molecule were available, could be used at the point-of-care and were cost effective. Loading the sample holder with other reagents specific to a desired target analyte molecule will permit quantification of a wide range of clinically important substances. Enzymes for diverse target molecules are available. The holder can also be used for either absorption or light scattering measurements, in addition to fluorescence. This greatly broadens the range of analytical targets. For example, light scattering can be used to quantify Cystatin C, the best biomarker of kidney health.

The analytical instrument that is part of this invention exploits modern miniature and low power optical components that are not part of current commercial systems. Because of the use of such components, this instrument can be battery operated, in contrast to current systems. Hence, it is small, and hence easily portable, about the size of a white board eraser. There are few limitations on the locations where the invention can be used because it is small, battery powered and easily portable.

The analytical instrument has a number of advantages, including the fact that it is compact, of a size well matched to the handling of diverse samples, neither too large nor small. The instrument can be used on a table or other surface, or else hand-held in a building, vehicle, the field or other location. There are many alternative designs for the optical, electronic and mechanical aspects of the instrument. It can be used without ancillary optical components, such as lenses or mirrors. The performance of the instrument is well matched to the requirements for the analysis of clinical and other samples, with adequately low noise and good signals. The instrument will cost substantially less than current desktop analyzers for performing the same analyses.

The instrument can be used for analysis of a variety of target molecules, if there are enzymes or other recognition molecules available to pick them out in unseparated samples. Personnel can use this instrument with little training, given its simplicity. Analyses can be obtained in a few minutes, with no need to send samples to a central laboratory with all the accounting and reporting that entails.

### BRIEF DESCRIPTION OF THE FIGURES

FIG. 1 is a schematic edge-view of a sample in the sample holder subjected to exciting light from a source and emitting fluorescence light which passes through a filter, which is tuned to the fluorescence, to a detector, or scattering the incident light through a filter tuned to its wavelength to a detector.

FIG. 2 is a schematic of the basic structure of the sample holder with a sample inside seen on edge and end (FIG. 2(a)), edge and side (FIG. 2(b)) and plan view (FIG. 2(c)).

FIG. 3 is a schematic of the end view of the alternative ways to hold the top and bottom plates at the desired separation and bond them together. A liquid sample 203 is between the two plates.

FIG. 4 shows photographs of squares one-half inch on a side of organic mesh materials within the holder to insure uniform distribution of the solution of the recognition molecules and water-soluble plastic and to delimit the area covered by that solution.

FIG. 5 is a schematic of the end views of the sample holders showing alternative ways to array molecular recognition materials, notably enzymes, within the holder during its construction. In these schematics, the holder is filled with the liquid which carries the recognition molecules into the holder. The liquid is partially removed by drying during manufacture of the sample holder to make room for entry of the sample prior to measurements.

FIG. 6(a) is a schematic cross-sectional diagram of the process of and result of dispensing the solution of water soluble polymer and necessary reagents onto a mesh atop the bottom plate of the sample holder being fabricated, prior to partial drying of the solution.

FIG. 6(b) is a schematic cross section of the two plates of the sample holder with the mesh, dissolved polymer in solution, reagent molecules and sample.

FIG. 7(a) is a schematic of four phases in the preparation of a functionalized (reagent containing) sample holder. Top Left: the holder bottom plate with the top spacer-adhesive strips on its side. Top Right: The holder with the mesh in place. Bottom Left: Transfer of a measured amount of the polymer and reagent solution onto the mesh. Bottom Right: The finished holder after partial drying of the solution and prior to its sealing with the top plate in place. FIG. 7(b) shows an alternative to use of a mesh by producing hydrophyllic regions on the interior face of one of the two plates.

FIG. 8 is time histories of the fluorescence signal intensity from an amplified detector for solutions of polyvinyl alcohol that were dried using dessication and vacuum means for the indicated number of minutes, showing that drying times for the particular conditions used of 10 or more minutes provided stable behavior.

FIG. 9 (Left and Right) are side views of the holder, and (Center) a face view of the holder, all showing means of sealing the ends of the holder between manufacture and use.

FIG. 10 (top) shows computed diffusion distances as a function of diffusion coefficient. FIG. 10 (bottom) shows values of the diffusion coefficient in water of diverse molecules as a function of their molecular weight. The combination of the two graphs permits estimation of diffusion distances for mixing of the reagent molecules released from the polymer upon sample insertion as a function of their molecular weight. Graphs for the specific reagents used for uric acid quantification are shown. They are uricase, horseradish peroxidase (HRP) and Amplex Red.

FIG. 11 shows face views of holder schematics for optical measurements only (FIG. 11(a)) and for electrical only or simultaneous electrical and optical measurements (FIG. 11(b)).

FIG. 12 shows top and side schematic views of the holder with the diluent built into it having one chamber for reaction and analysis of the sample.

FIG. 13 shows top and side schematic views of the holder with the diluent built into it having two chambers for reaction and analysis of two different target molecules within the sample.

FIGS. 14(a), (b) shows top and side view schematics of the hand-held instrument for use with the sample holder to perform clinical analyses at the point-of-care.

FIGS. 15(a), (b) shows alternative designs of the optical module, without and with additional components such as lenses and mirrors.

FIG. 16 shows schematic cross section of the laboratory prototype instrument used to obtain the fluorescence data shown in FIGS. 17-20, which can also be used to measure scattered or transmitted that originates in the excitation source.

FIG. 17 is data showing the rate of change of the fluorescent signal intensity from the amplified detector as a function of concentration of prepared uric acid samples. The dashed line is a fit to the data based on the Michaelis-Menten equation for enzyme kinetics. The equation of that line is also shown. The goodness of the fit proves that the kinetics of the reaction that leads to quantification of uric acid are well behaved.

FIG. 18 is the data from FIG. 17 plotted on a log-linear scale to serve as the calibration curve for analysis of uric acid in transparent samples such as saliva and urine.

FIG. 19 is the calibration curve for blood diluted with a buffer solution to make it transparent to both the excitation and fluorescent radiation. The initial concentration of the blood sample was not known, so this curve was obtained by spiking the blood sample with known levels of uric acid solution and also using the (0, 0) point. The insets show for two concentrations the rate of intensity increase as a function of time, from which the slopes were plotted to make the calibration curve.

FIG. 20 is the time histories of clinical samples of saliva (left, diluted 2 to 1), urine (center, diluted 100 to 1) and blood (diluted 20 to 1) from three study participants, with two measurements for each combination of sample and participant.

### DETAILED DESCRIPTION OF THE PREFERRED EMBODIMENTS

In describing the preferred embodiments of the present invention illustrated in the drawings, specific terminology is resorted to for the sake of clarity. However, the present invention is not intended to be limited to the specific terms so selected, and it is to be understood that each specific term includes all technical equivalents that operate in a similar manner to accomplish a similar purpose.

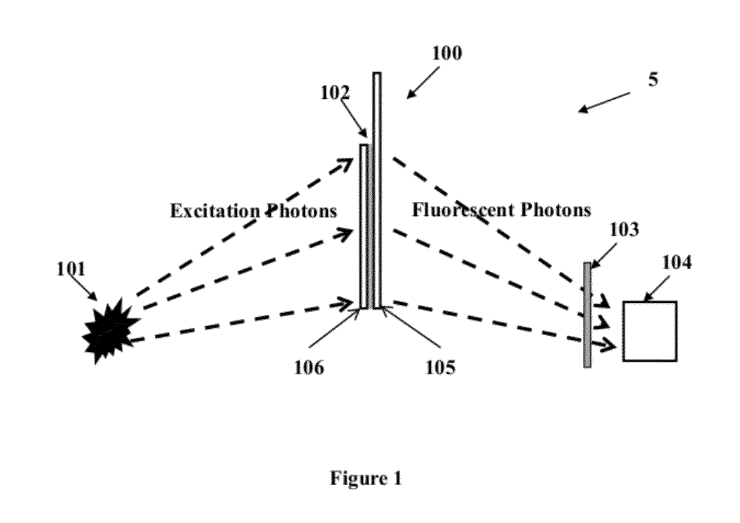

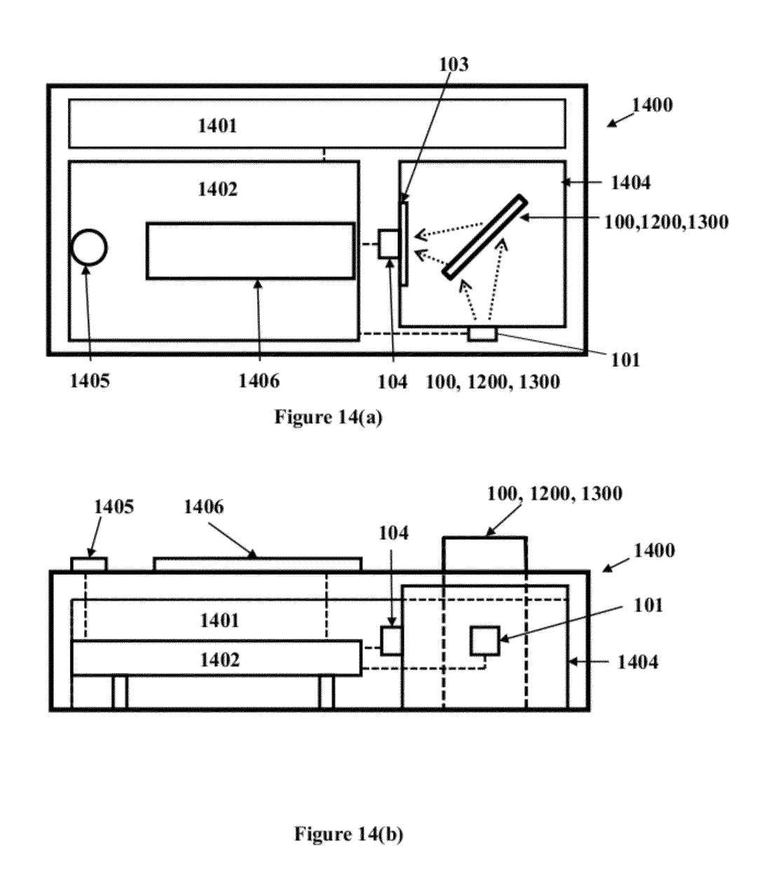

Turning to FIG. 1, the system 5 of the present invention is shown. The system 5 includes a sample holder 100 and the analytical instrument 1400 into which the holders are inserted after loading with samples prior to quantitative analyses. It is a schematic edge-view of a sample 102 in the sample holder 100 subjected to exciting light from a source 101 and emitting fluorescence light which passes through a filter 103 to a detector 104 of the analytical instrument 1400 (shown more fully in FIGS. 14(a), (b)). The light source 101 excites fluorescence in the liquid sample 102 that is retained within the holder. The filter 103 passes fluorescence light and stops excitation light, and the detector 104 detects the fluorescent light intensity emitted from the sample 102. Alternatively, the filter 103 can be tuned to the wavelength of the excitation radiation and pass scattered light from the source to the detector 104. The sample holder 100 has a bottom plate 105 and a top plate 106.

The sample holder 100 receives the liquid samples 102. The liquid samples 102 can be loaded quickly by unskilled personnel with clinical or other liquid samples using a dropper. The liquid is retained within the holder 100 by a combination of barriers and capillary forces. The holder 100 is inserted into the analytical instrument 1400 within seconds of being loaded for qualitative or quantitative assays of the concentration of specific molecules within the sample 102. During this time, chemicals preloaded into the holder 100 interact with chemicals in the sample 102 to produce materials that can be detected optically within the analytical instrument 1400. That instrument 1400 is generally a desk-top device, but it can also be a much smaller hand-held system. Within the instrument 1400, a source of photons strikes the sample 102 that is within the transparent holder 100 to excite fluorescence light indicative of the concentration of the target molecules in the sample 102. A detector 104, also part of the instrument 1400, records the light of interest. Other optical components, notably filters 103, may also be part of the instrument 1400.

The present invention measures the concentration in a complex sample by providing chemicals that recognize the analytical target molecules. Thus, the system 5 does not require sample separations and employs one of the main types of chemical recognition. The kinds of molecules that provide the analytically-necessary specificity include DNA, antibodies, aptamers and enzymes. The system 5 is preferably concerned with the use of enzymes. However, the system 5 will also work with DNA, antibodies and aptamers as the recognition elements. Accordingly, though the present invention is described herein in terms of using enzymes, it will become apparent that other kinds of recognition molecules can also be utilized and fall within the spirit and scope of this invention.

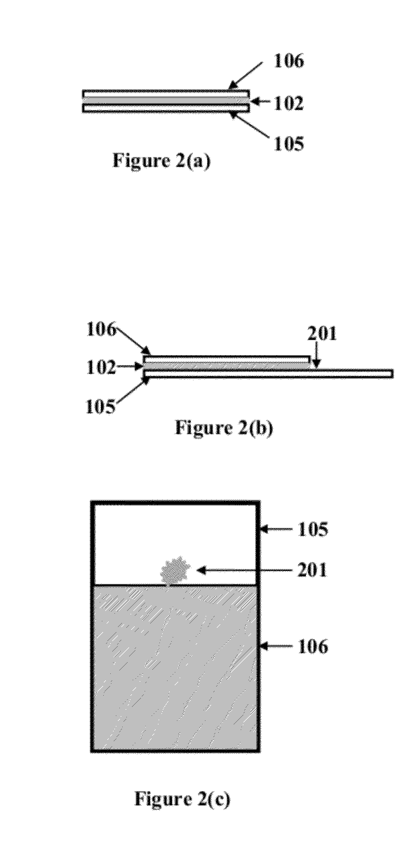

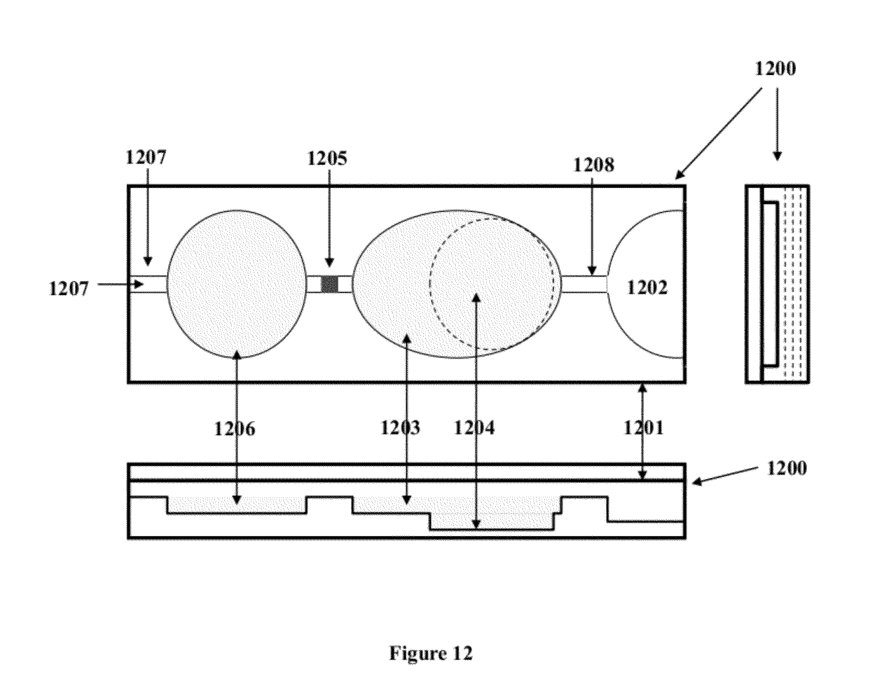

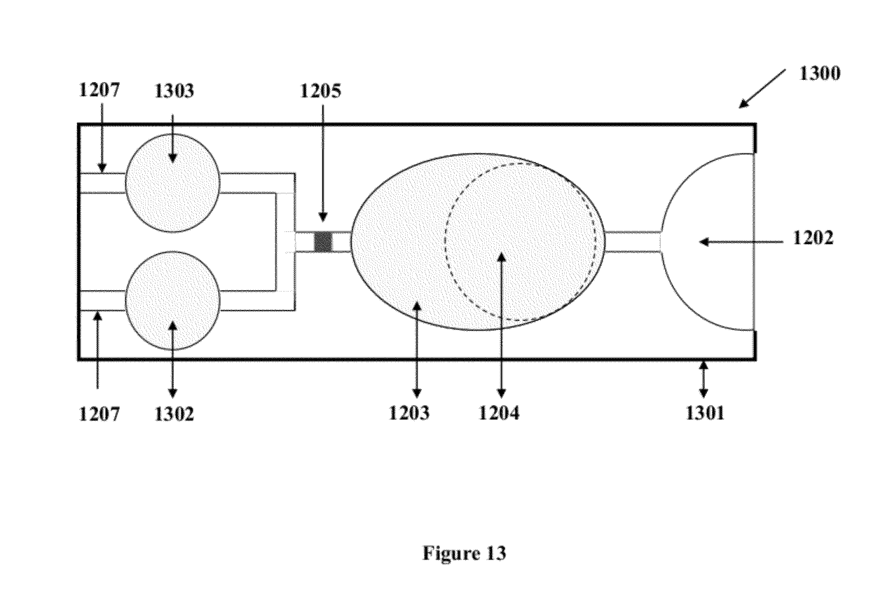

One preferred embodiment of the sample holder 100 will be described in greater detail below with respect to FIGS. 2-11. Another preferred embodiment of the sample holder 1200 is shown in FIGS. 12-13. And, the analytical instrument 1400 will be described in greater detail with respect to FIGS. 14(a), (b)-20.

### Sample Holders for Optical Micro-Fluidic Bio-Chemical Analyses

Turning to FIG. 2, the sample holder 100 of FIG. 1 is shown in greater detail. A flat and thin liquid sample holder 100 is provided for optical analysis of small liquid samples 102. The sample holder 100 is preferably configured to receive and hold liquid samples 102 with total volumes in the range from about 1-1000 microliters. An ordinary drop is about 50 microliters. The holder 100 has built into it means for retaining enzymes, which provide specificity for particular molecules during the analysis of complex fluids, such as clinical samples. The holder with the means for enzyme immobilization can be made of inexpensive materials using automated equipment, so it is inexpensive and disposable, that is, single use. The invention is characterized by its ease of use. Samples can be introduced onto location 201 using a simple dropper, so that the liquid touches the opening between 105 and 106, with the holder 100 filling quickly and uniformly due to capillary forces. An alternative embodiment to that shown in FIGS. 2(a) and 2(b) is to use a top plate 106 that is larger, possibly the same size as the bottom plate 105. In that case, plate 106 would have a hole at the position 201 to permit the sample dispensed from a dropper to contact the region between the plates. Then, as in the embodiment shown in FIGS. 2(a) and 2(b), sample would again wick into the holder 100 by capillary action. Very little training is needed for use of the holder. It is filled and then promptly inserted into an optical analytical instrument 1400 for automated readout of the concentration of the target molecules.

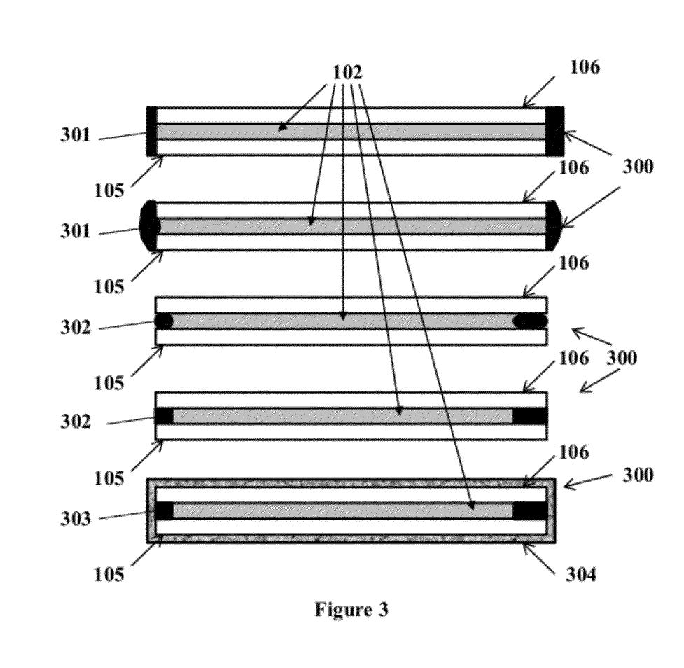

The sample holder 100 includes two plates 105, 106 and other interior or exterior materials comprising fixation elements 300 (FIG. 3) for reliably holding the plates 105, 106 parallel and close to each other. As shown, the plates 105, 106 are preferably flat and optically clear pieces of thin materials, usually glass or plastic. The thickness, dimensions and areas of the optical materials, which provide mechanical integrity and exterior surfaces for handling, can vary widely. Plate thicknesses in or near the range from about 500 micrometers to a few millimeters are practical. Plate widths can vary from about 5 to about 25 millimeters, and plate lengths can vary from about 20 to 80 millimeters. Areas from less than one square centimeter to several square centimeters are acceptable, though it should be apparent that other suitable sizes and shapes can be provided. The two plates can be of the same shape and size, but this is not required. If they have the same shape and size, all four of their edges are aligned during production of holders. If they have different shapes or sizes, they can be placed in any position relative to each other during holder fabrication, as long as their largest surfaces are parallel to each other.

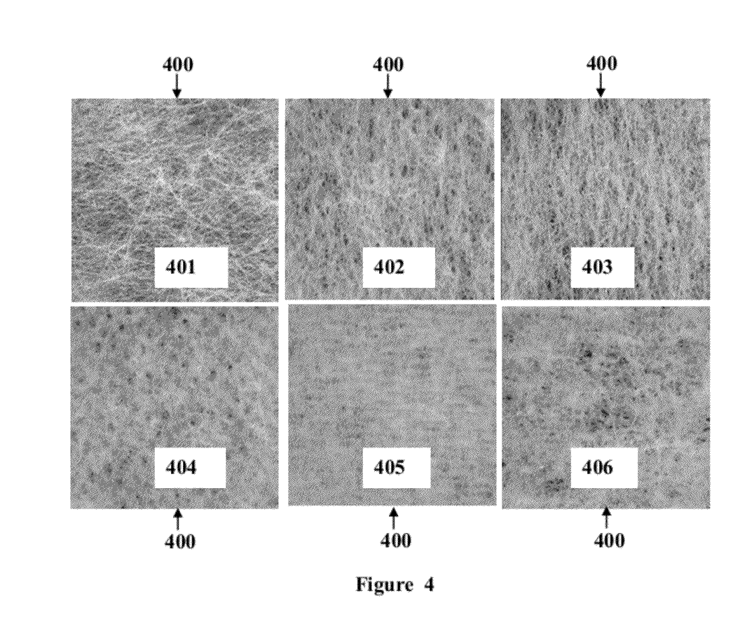

The thicknesses of the top 106 and bottom 105 plates can vary as a function of position in their areas in order to cause the sample thickness to vary as a function of position within the holder, or to define wells in the holder for storage of different chemicals for different purposes. The chemicals that will be stored within the holder to perform the analysis can be located on the flat surface of either plate or in two or more wells within the sample holder, generally but not exclusively in the bottom plate, to permit simultaneous analysis of two or more molecules, with the chemicals stored on the flat plate surfaces or in the wells by use of a mesh or a hydrophyllic coating in the bottom of the wells claimed below (FIG. 4).

Inside the space between the clear holder materials is a mesh or other structure (FIG. 4) on which is held molecules of one or more enzymes, which interact with the analytical target molecules when a sample is introduced into the holder. The interior surfaces of the holder can also be treated to serve the function of enzyme immobilization. The compositions of the interior materials or surfaces can vary widely. They have two primary requirements. One is a fine (roughly, micrometer) structure, so that short diffusion times are adequate for interaction of the enzyme molecules and the target molecules, one the sample is introduced into the holder. The other requirement is a surface chemistry that will hold the enzyme molecules in place by physic-sorption during storage prior to use, and them release them when the sample is introduced. It is also possible for the immobilized enzymes to be active without their release from the substrates inside the holder, in which case they can be chemically bonded to (immobilized on) surfaces within the holder.

FIGS. 2(a), (b), (c) are schematics of the overall structure of the sample holder 100, not showing the means to hold the major components apart and together or the locations or means for holding the enzymes. They illustrate the basic structure of the sample holder 100 with a sample 102 inside seen on edge and end (FIG. 2(a)), edge and side (FIG. 2(b)) and plan view (FIG. 2(c)). The bottom plate 105 has the same width as the top plate 106 (FIGS. 2(a), 2(c). However, as shown in FIGS. 2(b), (c), the bottom plate 105 is substantially longer than the top plate 106, to define a sample receiving location 201. The sample receiving location 201 is where the sample is dispensed so that it enters the holder by capillary action without the use of pumps.

Thus, the sample holder 100 can include a number of components, each of which can be made of many different materials and geometries. Two flat and generally thin structural pieces (“plates”) are provided that are made of optically transparent materials with areal dimensions in the range from a few millimeters to a few centimeters. Orthogonal dimensions of a few centimeters are typical. They can be made of any glass or plastic or other transparent material, ranging in thickness from about 100 micrometers to a few millimeters. Their shapes will commonly be rectangular, but other shapes, which preserve the functionality, are permitted. The shape of the two pieces comprising the structure can be same, similar or different. Between their manufacture and their becoming part of a holder, the plate surfaces can be cleaned, conditioned or coated by any physical means, such as exposure to a plasma, or any chemical means, such as dip coating, with or without prior lithographic patterning.

Turning to FIG. 3, the fixation elements 300 are shown to stably hold the structural pieces parallel to each other at separations that range from a few micrometers to a few millimeters. FIG. 3 is a schematic of the end view of the non-limiting alternative ways to hold the top and bottom plates 105, 106 at the desired separation and bond them together. The fixation elements 300 form a space between the bottom and top plates 105, 106, and the liquid sample 102 occupies the space between the structural plates 105, 106.

As shown, the fixation elements 300 can be an adhesive material 301 that holds the plates 105, 106 at the desired separation and bonds them together. The fixation elements 300 can also be spacers 302 that determine the plate separation and also provide the bonding function. Or, the fixation elements 300 can be an adhesive tape 304 that bonds the two plates 105, 106 together with internal spacers 303 that determine the plate separation. That space is preferably in the range from about 50-500 micrometers. The space must be stable over the storage and use lifetime of the holder to within a few micrometers. Non-limiting alternative geometries are shown on the left and right in FIG. 3 to illustrate the variety of spacer and fixation options. Thus, the fixation elements 300 affix the two structural plate pieces 105, 106 stably in relation to each other. Once manufactured, the dimensions of the holder 100 must remain stable to within a few micrometers, at most, until the holder is used and discarded. The fixation elements 300 can extend the entire length (or a portion of the entire length) of the top plate 106 that overlaps with the bottom plate 105. Alternatively, multiple fixation elements can be positioned along the length of the plates 105, 106.

Whatever the means of fixation of the two plates in stable and lasting position relative to each other, the separation can be determined by several means. One is the use of tapes, rigid forms with adhesives or settable epoxies, as shown by 301. Another is the use of spacers that do (such as spacer 302) or do not (such as spacer 303) also perform the function of adhesion and fixation. Spacer elements 302 can consist of beads, wires or other shapes embedded in settable epoxies, where the beads, wires or other shapes insure that the plates are the required distance apart and the epoxy serves the function of fixation by adhesion.

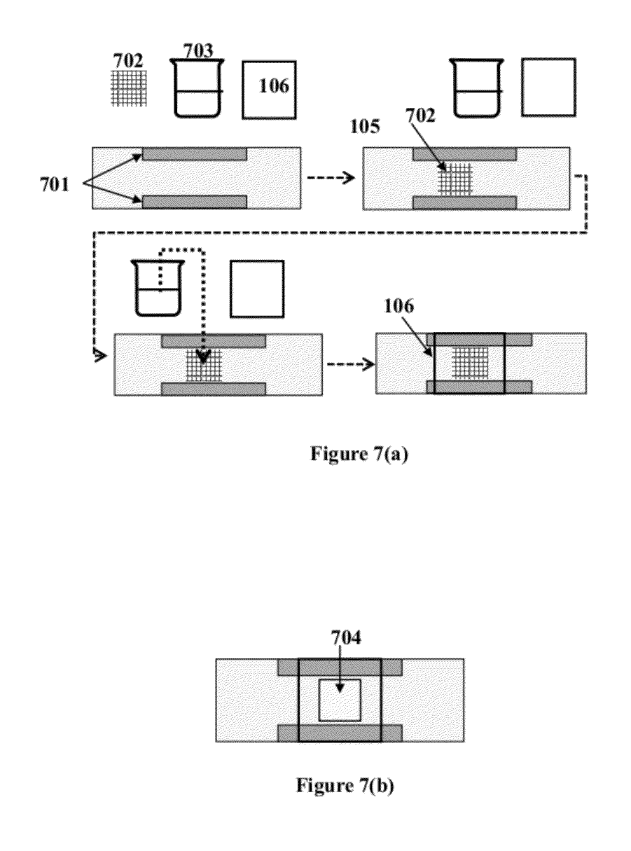

Turning to FIG. 4, various mesh elements 400 are shown to insure that the chemicals stored within the holder prior to its use will be in the desired locations. This is preferably accomplished in either of two ways. The first is to pattern one or both interior surfaces of the holder plates so that the water based solution of the chemicals will coat only the desired region within the holder. This can be done by making that region hydrophyllic and all other interior surfaces hydrophobic. Additional details are provided with respect to the description of FIG. 7.

The second way to insure that the stored chemicals are only in the correct areas is to use a mesh 400 within the holder 100, which will both insure even spreading of the chemicals and insure spreading over only the desired regions when they are dispensed onto the holder plate during manufacture. When the drop of the solution with the dissolved plastic and the chemicals to be imbedded in the plastic is put onto the mesh, it spreads out uniformly over the mesh and goes only as far as the mesh edges. Both of these actions are very desirable. To accomplish them, one has to pipette just the right amount of solution onto the mesh already in place on the surface of plate 105.

The mesh 400 can be made of a wide variety of natural materials (such as cellulose) or artificial materials (notably plastics), any of which must be wet by water-based samples or solutions. The meshes can be cleaned, conditioned or coated prior to their being built into a holder by any physical means, such as exposure to a plasma, or any chemical means, such as dip coating. The mesh 400 can have a wide variety of shapes and sizes, depending on the detailed design of the holder in which it will reside and function. The orientation and position of the mesh 400 within the sample holder 100 is constrained only by the viewing solid angle from the detector within the analyzer 1400 into which the holder will be inserted for measurements, and by the ability of the sample to entirely wet the mesh by capillary action when the sample is placed onto the holder.

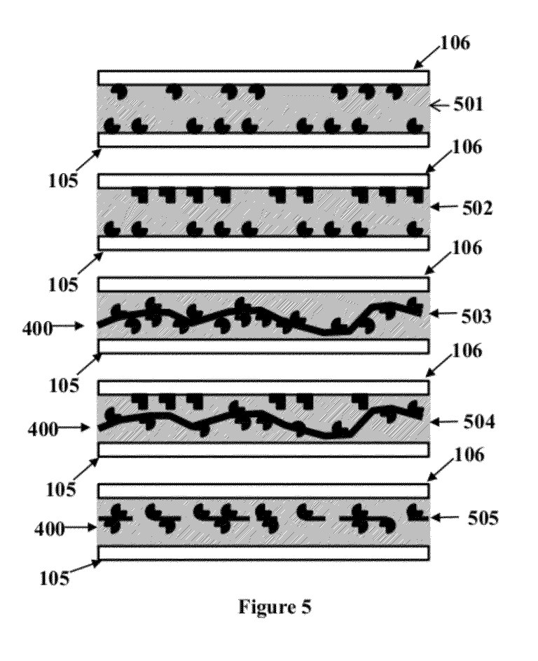

FIG. 4 shows photographs of squares one-half inch on a side of organic mesh materials 400 for placement into the holder 100 to insure uniform distribution of the solution of the recognition molecules and water-soluble plastic and to delimit the area covered by that solution. 401 is a paper tea bag, 402 is a lens paper, 403 is a shoe shine cloth, 404 is a toilet seat cover, 405 is toilet tissue and 406 is a paper towel. These materials are illustrative of the types of meshes that can be used in this invention. It is also possible to use thin plastic materials with a high density (>1000 per cm²) of small (1-10 micrometer) holes in place of the mesh 400. Pretreatment of the surfaces of the mesh by any means, such as glow discharge activation, is one of the elements of this invention. The mesh 400 is shown within the holder in FIG. 5. Mesh 400 generally has thickness in the range from 10 to 100 micrometers. The region between plates 105 and 106 has dimensions that can range from 20 to 1000 micrometers. The mesh is inserted into the holder during its manufacture as shown in FIG. 7(a).

The enzymes can be deposited on the surfaces of the holder 100 during manufacture of the complete holders 100. These surfaces might be one or both of the interior surfaces of the two plates 105, 106 or the surfaces of a thin fibrous or porous material (i.e., mesh 400) to be introduced into the holder 100 between the plates 105, 106 during its manufacturer, as shown in FIG. 7(a) . The mesh 400 would, for instance, be picked up and put in place within the holder during manufacture using a vacuum chuck.

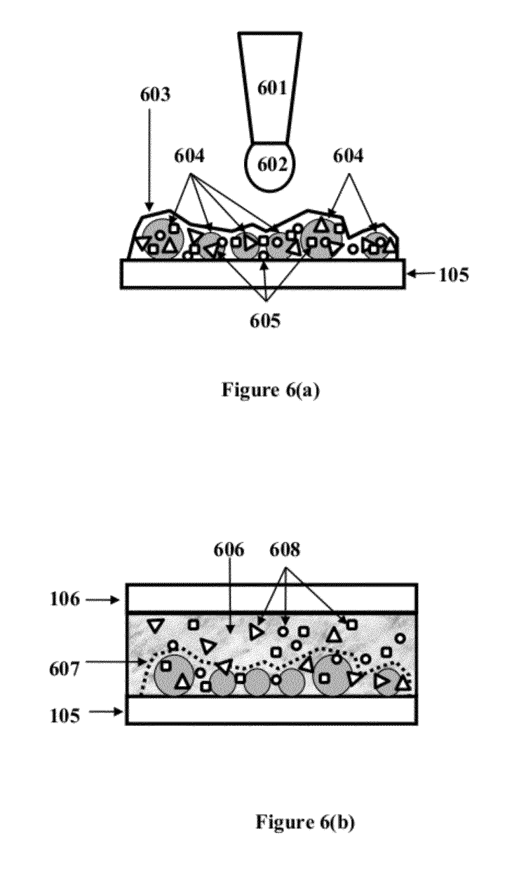

Preferably one enzyme, but possibly two or more different enzymes that will be used to produce the chemical reactions of interest, are provided immediately after introduction of the liquid analytical sample. The method for the introduction of the enzymes is illustrated in FIG. 6. The steps for manufacture of the entire holder are in FIG. 7(a).

Turning back to FIGS. 2 and 3, the fixation elements 300 are preferably provided along at least three sides of the holder 100 where the bottom plate 105 overlaps with the top plate 106. With respect to the embodiment of FIG. 2(c), the fixation elements 300 are provided along the bottom and two sides of the plates 105, 106. In addition, a temporary seal is provided at the open ends of the holder 100 through which the sample 102 will be loaded. In FIG. 2(c), the open end is between the top edge of the top plate 106 and the sample loading location 201. The seal is provided between manufacture and use in order to maintain an internal atmosphere with adequate humidity of preserve the activity of the enzymes and prevent their denaturation or other undesirable changes. The humidity seal will be removed by peeling it off shortly before introduction of the sample and performing the analysis.

A water-impermeable envelope contains the sample holders 100 between the time of production and use. It might be required to have an appropriate humidity within the envelope to maintain the locations and viability of enzyme molecules during storage without having to seal the ends of the holder during manufacture. This option is discussed below. The envelope has a small notch cut or clipped at some position along any of its edges to permit easy tearing of the envelope to remove the holder immediately prior to use.

There are many alternatives for each of the above cited components, including different chemistries and structures, some already cited. The surfaces on which the enzyme molecules will reside between manufacture of the completed holder and its use are a key part of this disclosure. There are options for those surfaces. Some non-limiting illustrative embodiments of those possibilities are shown in FIG. 5. It shows a schematic of the end views of the sample holders 100 with alternative ways to array molecular recognition materials, notably enzymes, within the holder during its construction. In these schematics, the holder 100 is filled with the liquid which carries the recognition molecules into the holder. The liquid is partially removed by drying during manufacture of the sample holder to make room for entry of the sample prior to measurements.

Element 501 is an arrangement in which the same recognition molecule is attached on both the bottom and top plates 105, 106, 502 has different recognition molecules attached on each of the two plates. The molecules can be attached, for instance, by treating the plate surface with an adherent layer that would grab the enzymes from a pre-treatment solution and then immobilize the enzymes to the layer by physic-sorption or chemi-sorption. In 503, the recognition molecules are bonded only to a mesh within the holder, 504 shows two recognition molecules bonded to one of the holder plates and the mesh, and 505 had the recognition molecules bonded to a porous membrane within the holder. These few possibilities are only suggestive and do not exhaust all practical options. The gray areas indicate the sample location during use.

A very fundamental design decision for the place(s) to put the one or more enzyme molecules are (a) on the surface(s) of the plates or else on (b) the surfaces of some material introduced between the places during the process of manufacturing the holders. In both cases there are four options for preparation of the key surfaces, (a) simply clean them without changing their chemistry or structure, (b) alter their chemistry by either applying a thin coating or by some kind of treatment involving physical, chemical or even biological processes, (c) alter their structure by using one or more such treatments or (d) a combination of the above. These options will be discussed in the following section on manufacturing of the holders containing the enzymes.

It must be emphasized that chemical processing to produce drugs or other substances with enzymes requires strong immobilization of the enzymes to a surface. Then, they will remain in place during batch of continuous flow processes. In contrast, chemical analysis is a single shot event that requires enzyme emplacement but not immobilization. Enzymes will remain emplaced or adsorbed on a surface physically, without being chemically bonded to them, usually by the actions of Van der Waal's forces. Enzymes are immobilized on surfaces using chemical bonds or other means. While this invention does not require immobilization, it is acceptable for proper performance of the holder.

The possibility of using N (> or =2) enzymes in the same holder for simultaneous analysis of N target molecules in the same sample is enabled by this invention. FIG. 5 shows two instances of the use of a pair of enzymes. In such cases, one enzyme can react with one target molecule to produce, say fluorescent light of a particular color. That enzyme might be glucose oxidase, which is used for determination of blood sugar levels. At the same time, another enzyme can react with a second target molecule to generate light of a second color. It could be uricase, an enzyme employed for determine of uric acid levels in blood. Separation and measurement of the two colors will enable quantification of the two different target molecules.

The components described above can be made of many different materials. Each component of the holder must be made of materials that will perform the required functions. The components and options for their materials, some of which were already mentioned above, disclosed in the following.

Structural Plates. The structural plates 105, 106 are flat and thin transparent plates that form the primary structure of the holder. The plates 105, 106 must be transparent to both the incoming excitation light and the outgoing fluorescence. They will preferentially be made of glass, that is, amorphous inorganic materials. Plastics are also prime candidates because they are cheap. Transparent polycrystalline ceramics are also candidate materials for the plates. The specific compositions of the plates, whatever class of materials into which they fall, are not critical. If the natural clean surfaces of the plates do not have the chemical, structural or other properties most appropriate for the application of enzymes, as in FIG. 5, then those surfaces are subject to treatment to produce the needed properties.

Spacers. The fixation and spacing elements and the spacers 300, 301, 302, 303 (FIG. 3) between the plates 105, 106 keep the plates precisely separate and parallel. The spacer material can vary widely. They must be dimensionally stable, compatible with whatever they touch and not contribute any chemicals, by leaching or vaporization, to the interior of the holder, which would interfere with the chemistry or optics of its use. The spacers can be metals, alloys, ceramics, glasses, plastics or other elements or compounds.

Fixation Materials and Devices. Some of the fixation elements 300 for holding the plates in position relative to each other are also sketched in FIG. 3. They fall into two classes. The first is for the situation where the spacers 300, 301 and 302 also perform the function of fixation. In that case, the surfaces of the spacers 302 in contact with the plates 105, 106 must be either naturally adhesive or else coated with thin films of adhesives. In the second instance, there are separate materials 303, 304 for the spacing and the fixation functions, respectively. The materials and structures for the fixation of the two plates 105, 106 to each other can vary widely in composition and geometry, being metals, alloys, ceramics, glasses, plastics or other elements or compounds. Like the spacers, they must be either naturally adhesive or be coated with adhesive films so they adhere to the plates. The use of exterior devices to apply pressure to the outside faces of the plates and hold them against the spacers is also contemplated. They could be elastomer bands 304, as sketched in FIG. 3, metallic clips or any other inexpensive, easy-to-apply and non-interfering device made from any material.

Meshes and Related Materials. As noted in FIG. 5, the enzymes put into the holder 100 can reside on either of two types of surfaces, namely the interior surfaces of the holder or the surfaces of thin meshes 400 or other materials placed within the holder. The meshes 400 can be made of any materials that will accept the enzymes without degrading their activity and any geometry that will fit into the holder and permit the analytical sample to be readily and quickly wicked by capillarity into the holder. The mesh 400 or other materials can be essentially two-dimensional, that is, very thin in relation to the spacing between the interior surfaces of the holder, or substantially three-dimensional, and fill most of the interior space. All variations between these extremes and all geometries that permit sample entry without substantial steric or other hindrance are embraced by this invention. Meshes 400 that are very thin papers or else made of cloth are preferred. However, thin continuous films that have numerous holes to permit the analytical sample to contact both of their sides are also acceptable. Whatever their materials and geometries, it is necessary that the wet meshes have sufficient transparency or holes to (a) admit the excitation light to the analyte and (b) permit the escape of fluorescent light. Sample meshes are shown in FIG. 4. They are made of plastic or paper or any thin fabric.

The number of cm² of surface area of any type of mesh per cm² of holder area is clearly of interest. For a particular number of enzyme molecules dispensed onto the mesh 400, its surface area will determine the spacing of those molecules. This is significant because the distances over which enzyme molecules diffuse in available analytical times is naturally limited. That is, the spacing between enzyme molecules and their diffusion coefficients determine how face the recognition of the target analyte molecules will occur, and thence, the time required for an analysis.

A calculation for one simple mesh geometry gives an estimate of the mesh surface area. Assume the mesh has two flat layers of uniform fibers, all of the same diameter. All fibers in each layer are parallel and equally spaced from their neighbors. If R is the fiber radius, and the center-to-center distance of the fibers is NR, then the total fiber area in a holder area of (1 cm)² will be 2πR×(1/NR). For both layers, the mesh surface area is twice this value, or 4π/N cm² of mesh area per cm² of holder area. Hence, if adjacent mesh fibers touch (N=2), there will be about 6 cm² of mesh surface area per cm² of holder area. If N=6, that ratio will be about 2, so the mesh will have a surface area comparable to the both of the interior surfaces of the holder. If the mesh fibers are not arrayed in two flat layers, but form a three-dimensional structure to partially or completely fill the holder width, then the meshes can have much larger areas than the holders. This has two beneficial effects. First, it increases the total mesh areas for emplacement of enzyme molecules. Also, it distributes the enzymes in three dimensions throughout the holder width, reducing the distances and times over which the molecules must diffuse to contact target analyte molecules.

Surface Coatings. All of the components of the system 5, including the plates 105, 106, spacers fixation elements 301-304, and meshes 400 or other interior materials, have surfaces. If they are made of materials with proper surface properties, they will not have to be coated or otherwise treated. However, if such is not the case, then it will be necessary to coat one or more surfaces of these components with materials that have needed properties without any deleterious characteristics. The coating can be of any materials that will yield the needed surface properties. In general, their thickness will be one micrometer or less. They must have the ability to adhere uniformly and stably to the surfaces to which they are applied. They can be laid down by any process, physical or chemical. Their active surfaces, which will contact the enzymes and they liquid in which they reside prior to and after applications, which will also contact the analytical sample during use, will have to be able to be wet by both those types of liquids.

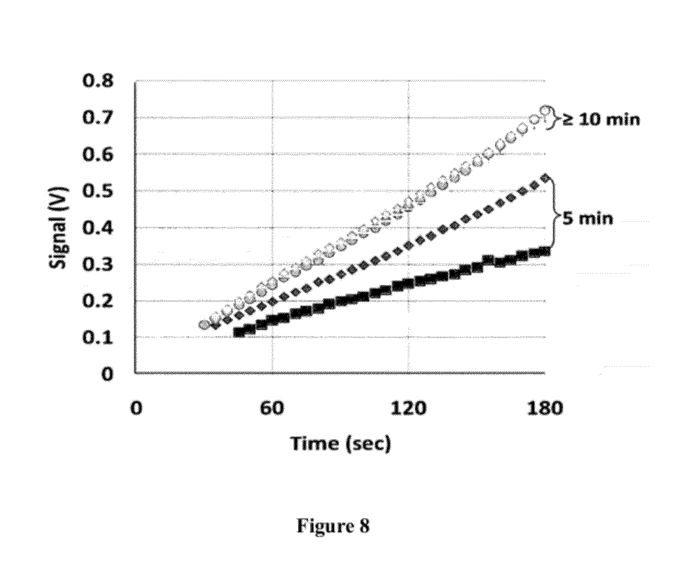

To demonstrate the importance of surface coatings inside of the holder 100, we prepared three holders using ordinary glass slides 105, 106. In all cases the glass plates were unused and cleaned thoroughly with ethanol prior to their assembly. We coated the two surfaces of one pair of plates with oil, left the second set as cleaned, and coated the third set with a thin film of a soap solution. Then, the plates were assembled into holders with 100 micrometer interior widths. Once the silicone on the sides of the holders was set, we filled them with water colored with food dye, so that the extent of the filling would be clearly visible. All holders filled in a few seconds with the solution of about 90 microliters dispensed from a pipette. The results are shown in FIG. 8. It is seen that the hydrophobic oil coating caused the holder to fill substantially less than the other two cases. Since most of the samples used with this holder will be water-based, this demonstration shown both the importance of surface coatings and how to achieve good performance with a simple coating. In short, the interior surfaces of the plates have to be hydrophyllic, as well as compatible with any enzymes that are emplaced on them.

Liquids. There are a few types of liquids relevant to this invention. One is any liquid that is used in cleaning of surfaces of the component parts of the holder prior to its assembly during manufacturing. Another is any liquid adhesive dispensed onto the surface of spacers or fixation means, prior or during the processes of manufacturing the holder. These two types of liquids man not be needed for some designs of this invention. However, the third type of liquid will always be used for the production of the holders, namely that liquid into which the enzyme molecules are put to produce that suspension to be placed onto the interior surfaces of the holder, or a mesh or foil it contains. In almost most, but not necessarily all cases, the liquid carrier for the enzyme molecules will be water or water-based. That is, it might be water into which other chemicals have been put in any acceptable concentration to maintain the viability of the enzymes during storage and use. For example, it might be necessary to control the pH of the liquid surrounding enzyme molecules during their storage. The fourth type of liquid germane to this invention is the analytical sample itself, which will almost always, but not necessarily, be water-based, as already noted.

Enzymes. The enzymes that will catalyze the desired reactions during the use of the holder will depend entirely on the nature of the target molecule(s) and the character of the other constituents (solutes or particles) within the samples. The type of enzyme, the chemical environment it requires during storage and use, the range of temperatures over which it will work effectively and any possible sensitivity to light during storage are considerations.

Holder Sealants. A removable bead of dispensed sealant material, or of tape is needed during storage to seal the slot through which the sample will enter the holder. Either of these geometries can be made of any materials, which are naturally adherent or else have surfaces coated with appropriate adhesives. The materials must be impermeable to water or any other chemicals within the holder after its complete production.

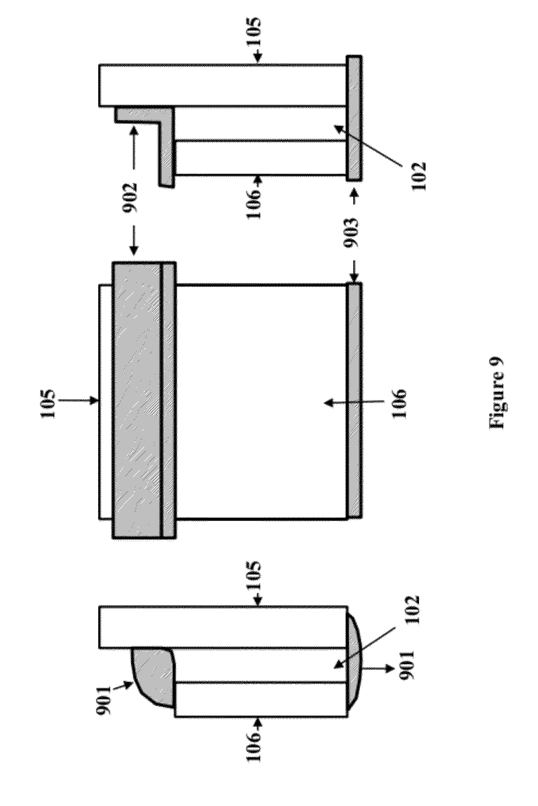

Envelopes. After its production, the holder has to be places within a sealed envelope that will both retain all desired chemicals in the region of the holder and exclude all undesired chemicals and particulates. The envelope might also have to be opaque to insure that light does not affect enzyme viability during storage. The envelope is preferentially plastic, although other materials are not excluded. It should be easy to open, with a notch on the side near one end to permit tearing it to open, such as is used for small plastic envelopes containing candy or other foods. The exterior of the envelope can have printed on it a serial number, the date of manufacture, the date by which the holder should be used (if there is any such limitation) and instructions for use. In summary, the protective measures of sealing the holder FIG. 9 and the envelope prevents (a) dirt or moisture from entering the holder, (b) moisture from leaving the holder, and (c) light from degrading chemical substances within the holder.

The holders of this invention are single-use, that is, they are discarded after each use. However, there are still some occasions where there is concern about cross contamination of the instrument by part of the sample from one patient, which might conceivably influence results obtained subsequently from a sample from another patient. If such is the case, it is possible to insert the loaded sample holder into a form-fitting transparent pouch immediately after the holder is loaded with a sample and before it is inserted into the instrument. Such single-use plastic sleeves would have only one side open for insertion of the holder and sample. Their length would exceed the distance to which the holder would be inserted into the instrument, and could be as long as or longer than the sample holder. These plastic sleeves are part of this invention.

Having identified the components and alternative materials, we now describe the manufacture of the sample holder, which is functionalized by its containment of chemicals required for the needed analytical reactions. FIG. 6 shows the major steps for production of the holder 100, and also the distribution of chemicals and the sample during use of the holder. FIG. 6(a) is a schematic that shows a step in the production of the holder, specifically the pipetting of the solution of the water soluble polymer and necessary reagents onto the mesh. It gives a cross-sectional diagram of the process of and result of dispensing the solution of water soluble polymer and necessary reagents onto a mesh 400 (shown in cross section as element 604) atop the bottom plate 105 of the sample holder being fabricated, prior to partial drying of the solution. The necessary reagents are embedded between manufacture and use of the holder in the partially-dried plastic within the holder, which is located on one surface of the holder plate 105 or on the fibers of the mesh 400.

The solution to be pipetted onto the mesh or an area without a mesh that has been treated so as to become hydrophyllic can have widely varying solutes with diverse concentrations. The material dissolved in the solution, which will provide the embedding function, can be any organic or inorganic materials, or mixtures of such materials, with water-soluble polymers such as poly vinyl alcohols with molecular weights in the range from 1000 to 4000 Daltons being effective materials. In laboratory tests, a 2 weight percent of poly vinyl alcohol with molecular weight of 2000 Daltons was employed. The reagents in the solution can be organic or inorganic materials which, by themselves or as a result of reactions they catalyze or participate in, will perform the functions of recognition of the target analyte molecules and transduction of the recognition steps into measurable optical or electrical signals.

FIG. 6(b) shows the condition within the holder after insertion of the sample. It is a schematic cross section of the two plates 105, 106 of the sample holder 100 with the mesh 400, dissolved polymer in solution, reagent molecules and sample. A pipette end 601 is provided to dispense a measured amount of solution. A solution 602 containing a dissolved polymer and multiple reagents is contained in the pipette end 601. The top 603 of the polymer is shown after drying. The mesh 400 has strands 604 (shown in cross-section in the figures). Reagent molecules 605 are provided, such as the enzymes uricase, horseradish peroxidase and Amplex Red for the quantification of uric acid in clinical samples. A solution 606 contains the sample 102 being tested, polymer and reagents after insertion of the sample. The line 607 indicates the former position of the partially dried polymer prior to insertion of the sample and dissolution of the polymer.

Also shown is the released reagent molecules 608 interacting with the sample 102. When the water-based sample of diluted blood, saliva or urine enters the holder and encounters the partially dried plastic layer containing the enzymes and other chemical(s), the plastic is fully dissolved. That frees the plastic molecules and, most importantly, the enzyme and other molecules to diffuse throughout the thickness of the holder, where they encounter the molecules of interest (such as uric acid) in the sample. Then the needed reactions happen, leading to a molecule (Resourfin in the case of uric acid) that is fluorescent. In response to light from the excitation source, the fluorescence molecule lights up in a specific color that the filter passes to the detector. The filter blocks the excitation wavelength.

The major steps in the production of the holder are shown in FIG. 7(a). It is a schematic of four of the phases in the preparation of a functionalized (reagent containing) sample holder. Starting at the top left, the holder bottom plate 105 with the top spacer-adhesive strips on its side is shown. Fixation elements 701 are provided in elongated strips having a thickness needed for separation of the bottom and top plates in the finished holder. The fixation strips 701 provide both separation and fixation of the two plates 105 and 106, as shown by elements 302 in FIG. 3. The fixation strips 701 extend a substantial distance along the sides of at least a portion (or the entirety) of the length of the plate 105. A piece of mesh material 702 is cut to a size to fit between the spacer-adhesive material 701. A container 703 is provided with the water-based solution of a polymer (preferably polyvinyl alcohol) and the multiple reagents needed to recognize the target analyte molecules in the sample and provide evidence, such as fluorescence, of the recognition processes.

Moving across to the top right figure, the holder 100 is shown with the mesh 702 in place. At the bottom left figure, a measured amount of the polymer and reagent solution is transferred onto the mesh 802. At the bottom right figure, the finished holder is shown after partial drying of the solution, and prior to its completion by putting the top plate 106 in place. Note that the drying step prior to emplacement of the top plate on the holder is not illustrated in the embodiment of FIG. 7(a). FIG. 7(a) shows the top plate 106 being centrally located relative to the bottom plate 105. However, the top plate 106 with the mesh and chemicals beneath is can be placed in any position relative to the bottom plate 105. For instance, the top plate 106, mesh 702 and chemicals can be positioned on the right side of the bottom plate 105 or at the very end of the bottom plate 105. In addition, the width of the top plate 106 can be smaller than the width of the bottom plate 105.

The bottom right view also illustrates that the mesh 702 preferably does not touch the fixation strips 701. In this manner, the chemicals stored in the region of the mesh preferably do not come into contact with the fixation strips 701. However the fixation strips 701 are also made of material that does not affect or contaminate the chemical reactions between the sample, the diluents, and/or the reagents or other chemicals.

As further shown in FIG. 7(a), the top plate 106 is fixed to the bottom plate 105 at the top and bottom of the illustrated embodiment by the fixation strips 701. The fixation strips 701 also provide a seal that prevents the liquid sample, reagent or diluents from escaping. On the other hand, the left and right sides of the top plate 106 are left open and not sealed. This permits the sample to be introduced by capillary action after contact with the bottom plate 105 at either side of the top plate 106. If the sample is introduced at the left side of the top plate 106, then the right side of the top plate 106 allows air to pass out from between the bottom and top plates 105, 106 as the sample enters that space. As discussed in connection with FIG. 9, a temporary seal can be placed over the right and/or left side of the top plate 106 and extend to the bottom plate 105 to protect the mesh 702 and reagent during storage and transport.

An alternative to use of a mesh to cause and limit the spread of the applied solution containing the dissolved plastic and the needed reagents is shown in FIG. 7(b). Here, the interior surfaces of the plate 105 of the holder is patterned with a hydrophyllic material in the usually-square and uniform region where it is desired that the solution spread and stop. That region is essentially the same area as would be covered by a mesh, as discussed in regard to FIG. 7(a). The remainder of the interior surface of the holder plate 106 can be partially coated with hydrophobic materials. The preferred embodiment is to make the boundary of region 704 to be hydrophobic, but the area outside of the region will remain hydrophyllic. Ordinary lithographic processes will be used to delineate the areas to which the hydrophyllic and hydrophobic coatings will be applied.

Four process steps are performed during production of devices based on this invention. They are (a) preparation of the surfaces on which the enzymes will reside between manufacture and use of the holder, (b) emplacement and treatment for immobilization of the enzymes and other molecules, (c) production of the holder with automated equipment, and (d) sealing of the volume with the enzymes into which the samples will be introduced prior to analysis. We will next address the procedures for treating the surfaces onto which the enzymes will be placed, and then describe the means for actually putting the enzymes onto either the interior surfaces of the holder or some material within the holder. Then, methods for production (assembly) of the holder will be disclosed. Since enzyme activity is humidity sensitive, we next provide materials and methods for retaining water in the volume within the holder until a sample is loaded. There are alternative approaches in which some of the steps can be performed in different orders. They will be discussed in the appropriate places in the following paragraphs.

Surface Preparation Options. As noted above, there are two types of surfaces on which the enzyme molecules will reside, either the interior surfaces of the structural plates or the surfaces of some material inserted into the holder, such as a mesh or porous thin film. Whichever surface is employed, there are two requirements, namely cleanliness, and the proper surface chemistry and physical structure. Cleaning of a surface can be accomplished using solvents or dry processes such as plasma incineration of particulate dirt on the surface of interest. All means of cleaning surfaces are germane to this invention. The cleaning of the surface of the plates, or the material to be put within the holder, will be done immediately before application of the enzymes to the plate and construction of the holder, or else right before putting enzymes onto the mesh or thin film and its emplacement into the holder during or after assembly of the holder.

Whatever surface is used to deposit the enzyme molecules, it can be treated by modifying its chemistry or structure prior to the deposit of the enzymes so that it has the appropriate chemistry and structure. Such treatment will insure that the enzymes remain active during storage of the holder and operate properly when the analytical sample is introduced. The treatment options include applying a thin coating of a desirable material to the surfaces that will accept the enzymes by any means and the treatment of the surface by any means, physical, chemical or biological, in order to beneficially alter the composition or geometry of the surface. Surface structural alterations can include the introduction of shapes in the surfaces or any type or scale by any means.

Emplacement and Immobilization of Enzyme or Other Analytical Molecules. There are two major reasons for using enzymes. Both involve their capabilities to catalyze (speed up) desired chemical reactions. The first is the production of chemicals in flow or batch processes. In such cases, the enzymes must be attached (immobilized) to a surface, so they will remain in place during flow processes or between batch processes. That is, the enzymes are used either continuously or repeatedly. They cannot be permitted to move out of the region where they are needed to produce their action.

There are several means of fixing (immobilizing) enzymes onto solid surfaces of diverse chemistry and structure. They include the following: covalent bonding of the enzyme to the surface; cross-linking some non-functional part of the enzyme molecule to a surface; entrapment of the enzymes within a material, such as a gel, which is permeable to the reactants and products for the reactions catalyzed by the enzyme; and encapsulation of the enzyme molecules within small structures, such as micelles.

The use of these means of immobilization require additional processing steps and, hence, increase the cost of making the structure holding or containing the enzyme molecules.

The second use of enzymes does not require either continuous or repetitive functioning. It is relevant and important to this invention, namely a one-shot use for catalyzing of chemical reactions during analysis. This is a prime example of a single-use application of enzymes, in contrast to the uses described above for chemical production. For the one-time use cases, chemical bonding or any other means of affixing the enzyme in place is acceptable, but not required. It is also possible to employ the weak binding of enzyme to a surface by physi-sorption (adsorption). In such cases, the enzyme molecules may leave the original surface on which it resides prior to use and still provide the needed functionality. Since this invention involves single use of enzymes, we are able to employ the fast and cheap method of adsorption for emplacement of the catalytic molecules onto a variety of structures.

Our process for putting the enzymes in place within the holder (either onto the interior surfaces of the plates or on a thin material that will reside within the holder) is now described. It is very straightforward and uncomplicated. A suspension of the enzyme molecules in water or other liquid, which will maintain the functionality of the enzyme molecules, is first prepared. In the most used case of water, the pH and temperature must be in appropriate ranges. Then, the suspension is applied to the desired location or material in a drop-wise fashion by using a pipette or other similar dispenser, or by spraying, or by dipping. Drop-wise dispensing of the suspension onto the desired surface using pipettes or needles with slots (like fountain pens) is the preferred approach. It uses the minimum amount of enzymes, which tend to be expensive on a per-gram basis. Spraying can also be made to use the suspension effectively. Dipping the plates into a suspension and withdrawing them vertically would work, but then both surfaces would be coated with enzymes. This would waste enzyme material and also introduce scattering (that is, background, which limits sensitivity) during optical analyses. The substrate or material wetted with the suspension is then placed in an atmosphere at the same range of temperatures, but having low humidity. This will remove the desired amount of water leaving behind the enzyme molecules. The areal density of molecules will be determined by their density in the suspension, and the area to which they are applied. The resulting areal distribution of molecules may not be uniform. However, this should not matter if the optical analysis system illuminates and views the entire region containing the enzyme molecules.

As just discussed, the suspension of enzyme molecules is applied to a surface or material on which it will spread laterally. The final area can be determined by mixing a non-interfering dye, such as food coloring or some transparent fluorescent material, into the suspension prior to dispensing it onto the substrate materials of or within the holder. The colored marker must not be optically active during the analysis. Nor must it be very optically dense, so that it will block either the incoming light to excite fluorescence or the outgoing fluorescent emission. The maximum permissible optical density is about 0.1. If a fluorescent material is employed to determine the extent of spreading of the suspension, it must not interfere with optical analyses using the holder.

Automated Machine Production of the Holder. The holder with all of its materials and parts will be quickly and cheaply manufactured by the use of automatic machinery designed, built and maintained expressly for manufacturer of holders ready for packaging and sale. The glass or plastic plates for the holders might be made by the manufacturer of the holders, but most probably would be bought from a company already making microscope slides or similar pieces of clear materials with the appropriate dimensions. We will first describe manufacturing processes for the case when the enzyme molecules are deposited on the surface(s) of one or both of the structural plates. Later, we will address the cases in which some material inside of the holder provides the base for emplacement of the enzyme molecules.

The plates are extracted from the containers holding them by grippers or, more likely, vacuum chucks, such as are used in the assembly of printed circuit boards in the electronics industry. The interior surfaces will be cleaned with jets of pressurized air or any other technique, and treated by any means physical, chemical or biological to produce the required surface chemistry and structure. If it is necessary to coat the surfaces of the plates on which the enzymes will be deposited, that can be done by dipping or spraying, followed by drying using air (at room temperature or with heated dry air), ultraviolet lamps or any other means.

Once the appropriate surface for the enzyme molecules has been prepared, a suspension of those molecules in water or other liquid will be placed onto the prepared surfaces by dipping, dropping, spraying or any other application means. A thin film of the suspension on the desired surface will result. That liquid coating might be partially dried by using a combination of warmth and dry air flow to achieve the desired areal density of enzyme molecules that is the needed number of molecules per square millimeter. The range of areal densities was discussed above. If only one plate surface need to be coated with enzyme molecules, then the facing plate surface, also prepared during processing of the first plate surface, will be moved into place near and parallel to the first surface. If the second surface also needs to be coated with the same or a different enzyme, then it will be prepared in parallel with the first before the assembly step.

Recall that there must be means in place to both keep the plates parallel and at the right separation and to hold them stably in place relative to each other during storage and use. FIG. 3 illustrates a few of the many means to accomplish these two requirements. If the separation is determined by some material of the precisely desired thickness between the plates, pieces of that material must be put in place on one of the plate surfaces after cleaning and surface preparation and before administration of the suspension of enzymes (if required for the particular plate). Again, pick-and-place automated machinery can be used to put the spacers in the correct places. The spacers might have the surfaces in contact with the plates coated with adhesives. In that case they perform both of the required functions, separation and holding the plates in place. Alternatives to the small spacers, some of which are shown in FIG. 3, are many. They include, for example, small hard beads or wires or incompressible meshes. All such approaches to maintaining the separation and parallelism of the structural plates are within the purview of this invention. If the means of separation is not also coated at least partially with an adhesive, or is not naturally adherent, then a separate method to produce a stable structure is also needed.

The second function of holding the two plates in tight registry can be accomplished by a variety of methods, some of them are illustrated in FIG. 3. Use of exterior compression devices, such as elastic bands or small metal clips, is practical. However, the preferred embodiment is to coat the edges of the holder with a material, such as silicone, which can be dispensed from a robot-controlled nozzle and then dry in place to perform both separation and stabilizing functions. The silicone, epoxy or other material, can be applied only to the two opposite edges of the holder, leaving the end opposite the slot for filling the holder open. Or else, all three of the edges not needed for filling can be coated, best in one motion of the robot dispenser. In a similar fashion employment of an exterior edge tape to produce the holder structure (as in FIG. 3), three sides of the holder can be sealed with one piece of adequately flexible tape.

During the approach to applying a viscous liquid, which will harden, or a tape to the edges of the holder, the plates must be help apart at the right separation and parallel until the applied materials hardens or sets. If there are spacers within the holder, they will provide the separation and parallelism, and the two plates must only be held during application of the viscous material and its drying or setting, generally for several minutes at elevated temperatures. Flat plates of precise thickness (shim stock) can be used during production of the holder and then removed. However, they could interfere with the enzyme coating applied earlier to interior surfaces of the plates. If a mesh is to be inserted later into the holder with the spacers and stabilizers already in place, shim stock spacers could be used during manufacture.

There are options for incorporating the mesh into the holder. If an interior mesh, or any type of materials to hold the enzyme molecules, is used, there are two options for its being put into the holder. The first is to place the enzyme-loaded mesh onto the surface of one of the holder plates before the two plates are spaced apart properly and then made into a unit already containing the mesh and enzymes. In this case, the holder surface onto which the mesh is placed may itself already be coated with enzyme molecules. The second is to make the holder without the mesh in place and then to insert it afterwards. In either case, the entire mesh might be coated with enzyme molecules. Or, only a central portion of the mesh might have emplaced enzymes. The latter case is preferable if the mesh is to be inserted into the holder after the holder is made. Then, the mesh will retain some stiffness useful for the insertion step.

Producing conditions to insure enzyme stability during storage is necessary. Conditions within the holder between the time when it is manufactured and used must be correct both to keep the enzymes in position, that is, uniformly distributed, and chemically active, neither denatured nor otherwise damaged. Since water will be the primary liquid used for the creation of the suspension of enzyme molecules, dispensing onto a surface or mesh material and maintenance of proper interior conditions during storage, we use water in the following paragraphs.

One issue is the amount of water that remains in the holder during storage. If there is too much water from the preparatory suspension, it will either exclude or impede filling the holder with the analytical sample. Any attempt to push out the residual water would remove many of the enzyme molecules. Also, the sample would be diluted to some unknown degree.

At the other extreme, removal of almost all of the water, save for humidity in the atmosphere, would have two undesirable effects. The first is that it might degrade the effectiveness of the enzyme molecules to recognize the analytical target molecules and promote the needed reactions during the analysis. This would vitiate the calibration curve for use of the holders. In addition, the lack of water on the surface, where the enzymes were deposited, might lead to their loss of the adhesion needed to keep them in place. Then, they might drop of the desired surface during handling prior to use, or wash off to produce a non-uniform distribution when the analytical liquid is placed into the holder.

The optimum is a very thin film of water surrounding the enzyme molecules, keeping them in place and maintaining their activity. The thickness of the water film can be a small fraction of one micrometer, generally in the 100 to few hundred nanometer range. Such a thin film will not be moved appreciably when the sample is admitted to the holder, so the positions (spatial distributions) of the emplaced enzymes will remain acceptable. The amount of water in the film will be small compared to the total volume of the sample put into holder. This is true even if both interior surfaces of the holder (typically 1 to 10 cm²), or a mesh with a relatively large surface area (several cm² per cm² of holder area) are used as platforms for the enzyme molecules. Water vapor is about 1000 times less dense than liquid water. Hence, a water film one micrometer thick will fill a volume one millimeter wide to 100% humidity. The required thin film of water can be produced during manufacturer by control of the size of the drops or sprays of the suspension that are put onto the surface holding the enzymes, and then using time, temperature and atmospheric humidity as parameters to drive off most of the water, but not all of it.

In laboratory tests, it was found that the combined use of a desiccant and a partial vacuum produced near optimum drying of the solution dispensed onto the mesh. FIG. 8 gives the time histories of the fluorescence signal intensity from an amplified detector for solutions of polyvinyl alcohol and the chemicals appropriate to analysis for uric acid. Those samples were dried using dessication with relative humidity levels of 1 to 5%, and a vacuum of 100 to 150 mm of Hg for the indicated number of minutes at room temperatures near 25 C. The data show that drying times for the particular conditions used of 10 or more minutes provided reproducible behavior.

Sealing the Holder. Two cases were discussed above. In one, both the slot where the analytical sample will be introduced during use of the holder and its opposite edge are open. That will function properly in retaining the sample because of capillary forces. However, the thin films needed to keep the enzyme molecules in place and active will evaporate. The humidity within the sample holder must be maintained during storage also, so the thin water films remain in place with appropriate thickness. Hence, all edges of the holder must be sealed until use. This requires application of the tape or other edge structural stabilizer and moisture-proof sealant to three of the edges of the holder.

Sealing of the fourth edge or the holder, where the sample will be introduced, is necessary to retain the interior water or other liquid. This edge sealant must be easily removed prior to filling the holder with a sample during use. It can be accomplished by the use of a bead of sealant 901, similar to that used on the edges, but still flexible, or by the employment of a piece of tape 902 that has a 90 degree bend along its length. FIG. 9 shows how the holder can be sealed between manufacture and use. In these schematics, the dimension normal to the plane of the two holder plates is greatly exaggerated for clarity and illustrative purposes. Left and Right are side views of the holder, and Center is a face view of the holder, all showing means of sealing the ends of the holder between manufacture and use. A waterproof adhesive 901 such as silicone or rubber is dispensed. A waterproof adhesive tape 902 with a right angle bend, and a flat waterproof adhesive tape 903 are provided. The tape 902 seals both the bottom and top plates 106, 105. The ends of the sealing material can extend beyond the edges of the holder for the person using the holder to be able to grip and peel off the sealant immediately prior to use of the holder. This is shown at the center view of the holder for the tape option. The dispensed elastomer sealant 901 flows to seal both plates 105, 106. As shown in the center figure, the tape 902 can extend beyond the plates 105, 106 so that the user can grab the ends to peel off the tape or elastomer.

There is a procedure to maintain the thin water films in the time between manufacture and use of the holders, which would not require sealing them. There are two conditions that would have to be met. First, the surfaces on which the enzyme molecules are emplaced might be treated to attract atmospheric water (humidity). That is, they would have to act as desiccants. And, they would have to provide that function without any deleterious effects on the enzymes. The second condition is that the atmosphere within the water-impermeable envelopes containing the holders during storage would have to contain adequate humidity. If these two conditions were met, the needed thin water films around and over the enzyme molecules would be maintained automatically without the need to seal either or both the edge where the sample will be introduced and its opposing edge. This would preclude having to produce and put in place the sealant materials described above, and would not result in any performance degradation. However, the use of seals at both open edges of the holder as in FIG. 9 is the preferred embodiment.

The holders described in this invention are especially useful for point-of-care measurements in doctor's offices, hospitals, clinics, accident sites, battlefields or elsewhere. They can also be employed for environmental analyses, process monitoring or any other situation or action involving liquid samples. Clinicians or other personnel use this invention by executing a series of simple actions in the following order: (1) turn on the analytical instruments and give it time (about one minute) to warm and settle; (2) remove the holder from refrigerated storage (between 10 and 10 degrees C.) in its sealed wrapping one half hour prior to use to permit it to warm to room temperature in the range from 20 to 30 degrees C.; (3) immediately prior to use, tear open the wrapper and extract the holder; (4) immediately thereafter, fill the holder with the (possibly diluted) analytical sample using a dropper, pipette or other means; (5) immediately after filling, insert the holder into the analytical instrument that will excite and record fluorescence or make other optical measurements; and (6) permit the instrument to record and store data as a function of time for a period that depends on the type of sample being analyzed.

Some analysis instruments quickly give a quantitative answer. Hand held glucose analyzers are a good example. After a few seconds, a digital reading appears on the display. However, most optical analytical instruments put out a signal that varies with time. In such cases, the reading at some particular time or the derivative of the signal intensity as a function of time or the integral of the signal over its duration, is the data that is calibrated to give the desired concentration of the analytical target.

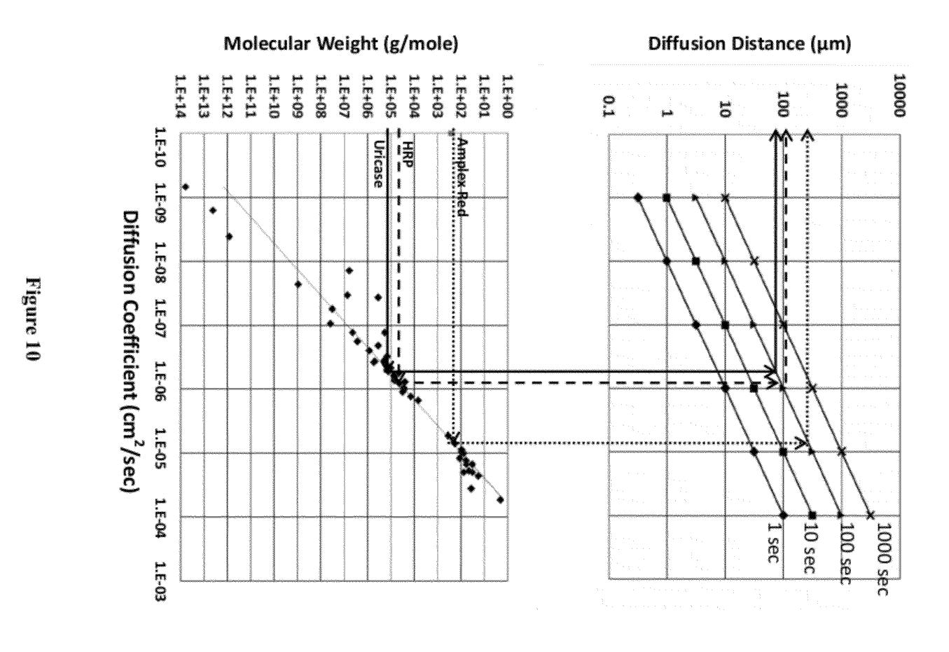

FIG. 10 contains diffusion data that shows the present invention works on a time scale of minutes, compared with current means to measure uric acid, which take at least one-half hour. The diffusion coefficients are provided in Nanomedicine, IIA: Biocompatibility Table 3.3, www.nanomedicine.com/NMI/Tables/3.3.jpg. FIG. 10(b) shows values of the diffusion coefficient in water of diverse molecules as a function of their molecular weight. FIG. 10(a) shows computed diffusion distances as a function of diffusion coefficient. The combination of the two graphs permits estimation of diffusion distances for mixing of the reagent molecules released from the polymer upon sample insertion as a function of their molecular weight. Graphs for the specific reagents used for uric acid quantification are shown in FIG. 10(b). They are uricase, horseradish peroxidase (HRP) and Amplex Red. This invention includes the use of ultrasonic agitation applied to the sample holder after insertion of the sample to augment mixing by diffusion.

There are alternative structures for the holder. The disclosure to this point has dealt primarily with optical measurements in order to quantify uric acid or other clinically-important molecules. However, it is also possible to use a modification of the current invention for electrical quantification of molecules of interest, as is done in current commercial glucose meters, such as the Precision Xtra Glucose Meter provided by TotalDiabetesSupply.com or the OneTouch UltraMini Glucose Monitoring System provided by drugstore.com, the contents of which are hereby incorporated by reference.

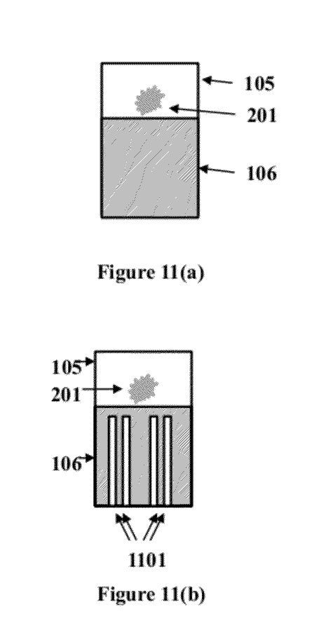

FIG. 11 shows how the holder can be made to contain electrodes for such electrical measurements. FIG. 11(a) is a face view of holder schematics for optical measurements only, and FIG. 11(b) is for electrical only or simultaneous electrical and optical measurements. Electrodes 1101 contact both the sample in the holder and contacts within the analyzer instrument for DC or AC impedance measurements. Those electrodes 1101 can be on the interior of either plate of the holder. In FIG. 11, the top and bottom plates are shown aligned to the end of the bottom plate even though this is not their only possible relative position. During the course of the alternative electrical measurements, a voltage is applied to both of the outer two electrodes to produce a current through the liquid sample. Simultaneously, the voltage between the two inner electrodes is measured. The known applied voltage and the measured voltage, and the spacings between the two outer electrodes and the two inner electrodes are used to compute the resistivity of the solution. That resistivity is uniquely related to the concentration of ionic materials, which in turn is uniquely related to the concentration of the target analyte in the sample.

Clinical samples include saliva and urine, in addition to blood. The concentrations of medically-relevant analytes, such as uric acid, in the different fluids vary widely. Hence, it is necessary to dilute the different sample in different amounts to insure that the sample has a concentration that falls within the dynamic range of the sample holder and associated instrument. That dilution can be done externally to the sample holder between acquisition of the sample from the patient and the insertion of the diluted sample into the holder. Such external dilution has disadvantages. First, it requires provision of additional equipment to the persons using the technology. Second, it requires another step prior to insertion of the loaded sample holder into the instrument for analysis. The extra steps take only a few minutes, but introduce the possibility of mistakes, which would give faulty readings. Third, the external dilution step requires additional operator training.

Hence, this invention includes an alternative design of the sample holder 100 described to this point. It has the diluent built into it, so that the requirement for external dilution of the original sample is avoided. The sample obtained from a patient, as it is gotten, can then be inserted directly into the holder, where dilution occurs by diffusion as shown in FIG. 10.

Turning to FIG. 12, another preferred embodiment of the invention is shown. The holder 1200 is shown in top, side and end schematic views with the diluent built into it. The bottom plate 1201 is formed by injection molding plastic to have a number of channels and chambers of varying depths. A sample entry point 1202 is provided at one end (the right in the embodiment) of the elongated bottom plate 1201. A ledge is provided at the entrance to the sample holder, as shown by the cross section of the lower shaped plate. In the sample holder of FIGS. 1-2, the sample is dropped, actually touched, on the lower plate 105, so the holder can be tilted and the sample come into contact with the space between the two plates, at which point it is wicked into the holder. In the current embodiment of the holder, the sample is placed into the end of the holder while it is held vertically so it flows into the hollow semi-circular region and is wicked into the dilution chamber. A narrow transfer channel 1208 connects the sample entry chamber 1202 to a diluent chamber 1203 that contains the diluent and a mesh or hydrophyllic coating of the bottom of the dilution chamber. The narrow transfer channel 1208 is an elongated channel that carries the sample to the diluents chamber 1203 under capillary action. As best shown in the side view, the sample chamber 1201 and the diluents chamber 1203 are relatively deep, whereas the transfer channel 1208 is relatively shallow in depth. The diluent chamber 1203 is filled with enough diluent to fill the chamber 1203. It will proceed as far as the hydrophobic coating 1205. The reaction and measurement chamber 1206 is relatively small and not as deep as the diluents chamber 1203.

A thin flexible region 1204 of the holder bottom plate 1200 is provided within at least a portion of the diluents chamber 1203. As shown, the flexible portion 1204 is deeper and thinner than the rest of the diluents chamber 1203. The reaction and analytical measurement chamber 1206 is provided in which the required reagents are stored within a thin layer of water-soluble plastic. The chamber 1208 can have a mesh, as in FIGS. 4-7, or a bottom surface treated with a hydrophyllic material, which will serve to insure that the solution wets only the bottom of the chamber when it is pipette into the chamber during manufacture.

A control channel 1205 is provided to link the diluents chamber 1203 with the reaction chamber 1206. The control channel 1205 is at least partially coated with a hydrophobic material that acts as a barrier to prevent fluid from entering the reaction and analytical chamber 1206 until the requisite pressure is applied to the thinned region 1204. A vent channel 1207 is at the other end of the holder 1200 opposite the sample entry 1202 end. The vent channel 1207 permits air to exit the holder 1200 when the sample is inserted and moved to the reaction and measurement chamber under the applied pressure.

As in FIGS. 1-3, the holder 1200 has a flat top plate of uniform thickness, which can be made of glass or plastic. The top plate is sealed to the bottom plate 1201 by a fixation and/or spacing elements 300, as discussed above with respect to earlier embodiments. The bottom formed plate 105 has raised sides that operate like rails that contact the top plate 106, as shown in the top right view of FIG. 12. A temporary seal can also be applied at the sample entry chamber 1202 and/or vent channel 1207, which is removed when the sample is taken. However, the narrow transfer channel 1208 and narrow vent channel 1207 do not permit the diluent and reagents to escape during storage. So, a temporary seal need not be provided.

During manufacture, the diluent is added to the diluents chamber 1203, and reagents are added to the reaction and measurement chamber 1206. A sufficient amount is added to each chamber 1203, 1206 without overflowing those chambers 1203, 12006. The hydrophobic material is also added to the control channel 1205. In operation, a sufficient amount of sample is added to the sample entry chamber 1202. The sample overflows the sample chamber 1202 so that it comes into contact with the transfer channel 1208. The sample then moves by capillary action from the sample insertion chamber 1202 to the diluent chamber 1203, where it mixes with the diluents (which can take several minutes). Depending on the precise geometry of the shaped bottom plate, one or two drops will be put on the open edge by the insertion chamber 1202. At that point the user (or the analyzer instrument 1400) presses inwardly on the flexible portion 1204 of the bottom plate 1201. This in turn raises the diluted sample above the barrier between the diluent chamber 1203 and the reaction and measurement chamber 1206. Pressing the flexible portion 1204 will tend to seal the entrance channel 1208 to prevent any substantial amount of liquid from escaping back to the sample entry chamber 1202. Under the force of the pressure created by the depression of the flexible portion 1204, the diluted sample enters the control channel 1205, overcomes the hydrophobic barrier, and enters the reaction chamber 1206 where it mixes with the reagents and is subject to analysis and evaluation by the analyzer instrument 1400.

As the sample moves from the sample chamber 1202 to the diluents chamber 1203, and as diluted sample moves from the diluents chamber 1203 to the reaction chamber 1206, air is also forced along the way. Accordingly, excess air can escape the holder 1200 through the vent channel 1207. The vent channel 1207 prevents the air from building up within the holder 1200 and restricting the flow of sample and diluted sample. Thus, all of the chambers and channels 1201, 1208, 1203, 1205, 1206, 1207 are in direct air and/or fluid communication with the adjacent one of each other.

As shown, the sample entry chamber 1202, diluents chamber 1203 and reaction chamber 1206 have half-circle, oval and full circular shapes. In addition, the respective chambers 1202, 1203, 1206 are configured with a suitable size, shape and depth to permit operation of the holder 1200. Depending on the detailed geometry of the shaped plate 1201, the amount of the diluent in 1203 will be in the range of 50-2000 microliters, the amount of the plastic and reagent solution placed in 1206 will be in the range of 5-500 microliters and the amount of the sample inserted into 1202 will again be in the range of 1-1000 microliters.

For instance, blood can be diluted 20 fold, namely 19 parts buffer solution to 1 part blood. Saliva can be diluted 2 fold, with equal parts of buffer and saliva. And, urine can be diluted 100 fold, with 99 parts buffer to 1 part of urine. It should be recognized that any suitable ranges can be utilized within the spirit and scope of the invention.

The size, shape and depths of the geometries in holder 1200 can be varied, and any suitable sizes, shapes and depths can be used. In addition, while the chambers and channels have all been created in the bottom plate 1201, it should be realized that one or more of the channels and chambers can also be created on the top plate. Thus, for instance, the diluents chamber 1203 can be a single uniform depth on the bottom plate 1201, and the thickness of the top plate can varied to create a thin flexible region that can be depressed.

Additional details on preferred dimensions for the holder 1200 are as follows. The bottom structure 1201, which is made of a transparent material, with plastic being the preferred embodiment, with length in the range from 2-10 cm, width in the range from 1-3 cm and thickness in the range from 0.5-4 mm. A reservoir of any shape with hydrophyllic interior surfaces in the sample insertion end 1202 of the bottom structure with lateral dimensions between 50-90% of the width of the bottom structure and thickness from 10-80% of the bottom structure, with a semi-circular or semi-oval shape being the preferred embodiment. A channel 1208 with hydrophyllic interior surfaces connected to the input reservoir having width parallel to the largest area of the bottom structure between 20-500 micrometers, and thickness normal to the largest area of the bottom structure of from 10-80% of the thickness of that structure.

A reservoir of any shape 1203 with hydrophyllic interior surfaces connected to the channel of any shape in bottom structure 1201 with lateral dimensions between 50-90% of the width of the bottom structure and thickness from 10-80% of the bottom structure, with an oval shape being the preferred embodiment. The reservoir 1203 with a thinned and flexible area 1204 toward the sample entrance end of the bottom structure of any shape and dimensions which permits manual pumping by application of exterior pressure of the fluids within the sample holder out of the reservoir into channels and reservoirs further from the sample entrance end of the holder. A micro channel at the exit end of the reservoir 1203 with dimensions similar to the channel 1208, which is coated with a hydrophobic material for 10-90% of the length of the channel on the bottom and both side walls of the channel, the remaining surfaces being hydrophyllic.

A reservoir of any shape with hydrophyllic interior surfaces in the bottom structure 1201 with lateral dimensions between 70-90% of the width of the bottom structure and thickness from 10-80% of the bottom structure, with a circular shape being the preferred embodiment. A micro channel 1207 at the exit end of the reservoir with dimensions similar to the channel 1208, which has either hydrophobic or hydrophyllic interior surfaces. A hydrophyllic material of any composition and geometry to fill all of part of the interior of the reservoir 1203, which will retain within its surfaces by capillary and other action any liquid for diffusional mixing with the sample after its insertion into the holder.

The top structure of holder 1200, which is made of a transparent material, with plastic being the preferred embodiment, but glass being an alternative material, with length in the range from 2-10 cm, width in the range from 1-3 cm and thickness in the range from 0.5-4 mm, with both the length and width matching those dimensions of the bottom structure 1201. Methods for cleaning the top and bottom structures of holder 1200 by any means, including application of mechanical force, use of wet chemicals, plasma treatment or irradiation with ultraviolet or other wavelength light. Methods for joining the aligned top and bottom structures of holder 1200 by any means, including application use of adhesives or any kind applied by any means with or without the application of mechanical pressure.

There are two preferred ways in which more than one target analyte molecule can be quantified simultaneously using the sample holders of this invention. The first is shown in FIG. 12. Here, all of the chemicals for analysis of both target molecules within the same reaction and measurement chamber 1206. In this case, the wavelengths of the light that is measured using two or more sets of filters and detectors would have to differ, so that the optical system in the analyzer can distinguish between the different wavelengths and, hence, between the different target chemicals.

Referring to FIG. 13, a second approach is to provide a holder 1300 with a bottom plate 1301 with multiple (two in the embodiment shown) reaction and measurement wells 1302, 1303. Thus, the single reaction chamber 1206 of FIG. 12 is replaced with multiple (and usually smaller) reaction chambers 1302, 1303. The holder 1300 has the same sample entry well 1202, thin region 1204 and diluents chamber 1203, as in FIG. 12. In addition, each of the reaction and measurement chambers 1302, 1303 has its own vent channel 1207. And, a single transfer control channel 1205 is provided, with each of the reaction and measurement chambers 1302, 1303 connected to the control channel 1205.

Here, the chemicals in each of the reaction and measurement chambers 1302, 1303 will pick out only one target molecule. In that case, the optical system in the analyzer instrument would have separate channels with different filters to see only the light from one of the respective reaction and measurement chamber. This embodiment allows for the simultaneous analysis of two target molecules. The holder has the diluent built into it and has two chambers 1302, 1303 for reaction and analysis of two different target molecules within the sample. This multiple-well arrangement is also germane to the simple sample holder for which the sample dilution is done externally to the holder.

The present invention provides a way of storing one or more enzymes or other recognition molecules, the key chemicals for the analysis of diverse samples, so that they are both viable and readily available. A very wide variety of liquid samples can be analyzed using any embodiment of the holder, as in FIG. 2, 3, 5, 12 or 13. This is true whether or not the samples require some kind of preparation between their acquisition and insertion into the holder. The holder does not require conventional enzyme immobilization, as is needed for flow or batch production of some drugs and other chemicals. The enzymes might be tied to the holder, but this is not a requirement.

The use of emplaced enzymes in a thin holder makes them readily available to the analytic sample, which leads to relatively short reaction and readout times. The use of thin samples is also fundamental to promoting intimate contact and proximity of enzyme and target molecules, and the associated short analysis times. The use of capillary forces insures that the holder will rapidly and completely fill with high confidence even when used by persons with little or no training and without any pumps.

The holder is easy to make, even by hand, and can be produced rapidly with automatic machinery in a production line devised for the purpose. Its manufacture exploits commonly-used manufacturing methods, such as robotic handling or components and dispensing of adhesives and sealants. They are compact and easy to store. The temperature sensitive enzymes within the holder are not a problem, though as with many medical supplies and foodstuffs, cooling during transport and storage is needed.

Proper handling will insure maintenance of enzyme viability between production and use of the holders with high confidence. The shelf life of the holders should prove to be comparable to those of many pharmaceuticals, namely several months. The holder is easy to handle by essentially unskilled personnel. Minimal training is needed for its use. The design is forgiving because if requires only approximate placement of the liquid onto the holder. It can be used equally well within a building, such as in a laboratory, or outdoors, for field testing.

The holder requires only simple ancillary equipment for its filling and use. An ordinary dropper or widely-available pipette is sufficient to load a sample into the holder. Doing that is well below the skill levels of clinical and other personnel that would use it. The design of the holder is very flexible. It can be of very many materials in widely varying geometries. For example, a great variety of internal meshes can be used. The holder can accept, store and use hundreds of different enzymes. Hence, the range of target analytes for use with this holder is very great.

The holder can be used over a wide range of temperatures if the instrument into which it goes for excitation and readout is calibrated for the specific temperatures of use. The holder does not require electrical connections to the analytical instrument. It is simply inserted into a slot for readings to commence. Because of the inexpensive and readily available materials of which it is made, and the automated processes for the manufacturer of holders, they will be cheap and entirely compatible with single-use (disposable) uses.

The holder does not contain dangerous materials that would constrain disposal. If it is used with clinical samples, it would be disposed of routinely as ordinary medical waste. The holder can be used for determining experimentally the absorption coefficients and fluorescence efficiency of a wide variety of liquid samples. The holder can be used for spectroscopic measurements, either absorption or fluorescence, and maybe various types of scattering. This design can serve as a standard for quantitative calibration of spectrometers, possible by the use of NIST-related solutions sealed into the holder. The holder disclosed here can replace the use of cuvettes, which are used by the millions in clinical and other research and medicine.

### Analyzer Instrument

Referring momentarily to FIG. 1, the system 5 of the present invention includes the sample holder 100, 1200, 1300 and the analyzer instrument 1400. The analyzer instrument 1400 is shown in greater detail in FIGS. 14(a), (b), and is only partially reflected in FIG. 1. The analyzer instrument 1400 is utilized with the sample holders 100, 1200, 1300 of FIGS. 1-13 to perform quantitative analysis of chemicals or bio-chemicals in complex samples by employing the holders 100, 1200, 1300. It uses small samples on the order of one or two drops of a complex liquid, notably clinical samples such as blood, saliva, urine and other bodily fluids, or other liquids from any source. The analytical specificity, that is, the ability to measure the amount of particular molecules in samples that have not been separated or otherwise pretreated is achieved by the use of recognition molecules. They might include enzymes, antibodies, antigens, DNA, RNA, aptamers and other molecules that will respond to only the desired target molecules in the complex liquid samples. Enzymes are the preferred embodiment.

The sample contacts the recognition molecules that have been preloaded into disposable holders disclosed by the same inventors. The recognition step results in optically active molecules which will emit fluorescence light when stimulated by shorter-wave length radiation. This invention includes the stimulation source, intermediate optics (at least filters) and a detector for measurement of the fluorescence, which is proportional to the number of target molecules in the sample. Ancillary and integrated electronics are also part of this invention. There are very many alternative embodiments for the component optics, electronics and mechanical modules of the instrument. The disclosed instrument is a portable system that can be mass-produced and employed by personnel with very little training for clinical research and point-of-care clinical diagnostics.

A primary goal of the invention is to obtain a quantitative measure of the amount of a particular target molecule within the sample placed into a disposable holder prior to its insertion into the analyzer for measurement. Chemical reactions between particular molecules within the sample and other molecules produce molecules that will fluoresce. The other molecules and be either (a) mixed with the sample prior to emplacement in the holder or, (b) as in our related invention, mixed by diffusion when the sample is loaded into the holder containing all needed reactants. The number of fluorescing molecules will depend on the number of target molecules of interest in the sample. The amount of fluorescent radiation will depend on the number of fluorescing molecules. Hence, the concentration or numbers of the molecules or interest will be uniquely related to the brightness of the fluorescent light. The curve relating the concentration of number of analyte molecules to the light intensity (actually a signal from the detector of the fluorescent light) is termed a calibration curve. It is determined by measuring samples of known concentration and plotting the voltage or other detector signal against the concentration of the molecules of interest.

The analyzer instrument is entirely synergistic with the sample holders described earlier. That is, it is possible in principle to modify current large optical analytical instruments, which usually require cuvettes that have long optical paths in a sample and are limited to substantially transparent samples, to accept the new sample holders. However, that is not a practical approach to employment and exploitation of the thin holders of this invention. The holders of this invention can employ samples that have relatively high optical densities, such as little-diluted blood. Further, the large sizes of most current analytical instruments are a major disadvantage due to their inefficient use of light from the source. This new analyzer, described herein, has the advantage of overall small size. It would typically be 8-12 centimeters long, 5-10 centimeters wide and 2-4 centimeters high. Hence, the optical paths are short and the light from the source or sample is used efficiently. This reduces the intensity required from the light source, which permits the use of lower powered sources. They, in turn enable the use of batteries for powering the analyzer. And a battery-powered instrument does not have to be tethered by a power cord, which enable mobile use at the point-of-care or filed locations.

FIGS. 14(a), (b) shows top and side view schematics of the hand-held instrument 1400 for use with the sample holders 100, 1200, 1300 to perform clinical analyses at the point-of-care. The instrument 1400 includes batteries 1401, a printed circuit board 1402, the sample holder 100, 1200, 1300 containing the sample to be evaluated, an optical module 1404, controls 1405, and a display 1406. The batteries may be single use or rechargeable varieties. The printed circuit board 1402 contains a microprocessor, ancillary components, such as DC-DC converters, a driver for the excitation source and connectors. The processor can also be in communication with a storage or memory to run software, or can be provided as an ASIC device. The printed circuit board 1402, and particularly the processor, controls the operation and functions of the instrument 1400. The instrument can be built so that the only to readout its data is by the display. It can alternatively be made to contain a wireless transceiver for uploading of revised programs, input of patient information and exfiltration of information from analyses. Wireless transmission of patient analytical information to a nearby personal computer is the preferred embodiment.

The batteries provide power for the analyzer. They permit the analyzer to be used without an electrical cord, so that it can be conveniently carried on the person of a medical service provider, such as a nurse or doctor. The use of a printed circuit board within the analyzer is standard practice for modern instruments, since it provides a cheaply manufacturable and reliable way to connect the components. The microprocessor has both program and data memory. Hence, the program that turns raw voltages into clinically-useful information resides in the instrument, and can be upgraded when desirable. The data memory permits records from many patients to be stored in the analyzer prior to their readout. The processor also responds to actions, such as actuation of the controls on the analyzer. It also effects the receipt or transmission of wireless signals and the display of data.

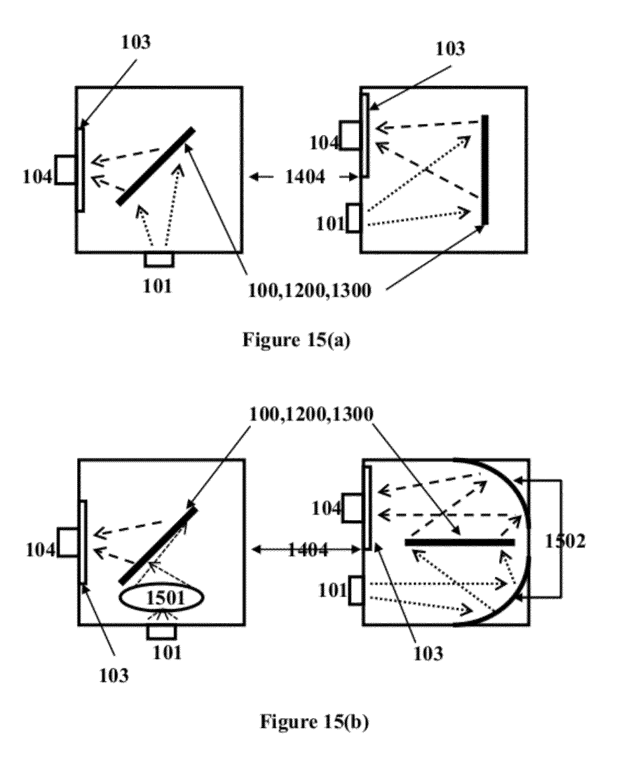

One aspect of this invention is the possibility of diverse variations in the arrangements of internal and external components. The batteries, electrical module, and optical module within the analyzer can have widely different shapes, sizes and positions within the mechanical housing of the analyzer. Similarly, the shape and size of the housing can vary greatly. The position of the slot for insertion of the sample holder, and the control button(s) and display, are little constrained. The basic function of the analyzer will be maintained in any of many interior and exterior embodiments. FIGS. 15(a), (b) are non-limiting illustrations of several possible variations for the interior modules and for external features. They vary in the relative positions of the source and filter-detector combination, the orientation of the sample holder within the module and the absence or employment of additional optics such as lenses or mirrors. For example, a lens 1501 can be provided to gather excitation radiation and focus it onto the sample, and mirrors 1502 can be provided to gather excitation radiation to focus it onto the sample and to gather fluorescent radiation to focus it onto the detector.

Optical Module. The optical module 1404 is able to accept the insertion of a sample in a thin film holder 100, 1200, 1300. It is possible to use with this invention other sample holders that are not thin for some samples. For example, holders with square, rectangular, round and other cross sections might be employed. The thin film holder is highly favorable for two reasons. It permits exciting and fluorescence or scattered radiation to go into and out of the sample. And, it requires less dilution for dark samples like blood. These are broad points generally applicable to the holders. The optical module 1404 includes an optical excitation source 101 that produces fluorescence from the sample (as also illustrated in FIG. 1). The filter 103 passes fluorescence radiation and absorbs other light, notably some of the light from the source which is scattered about within the optical module 1404. The detector 104 is part of the optical module 1404. The interior of the optical module is preferably black in color, either due to the color or the materials used for its construction or by coating by a black material, and possibly have a rough surface in order to absorb unused excitation light and reduce the background signal from the detector.

Electrical Module. Means of connecting electrically all the components for the instrument 1400, including wires soldered in place, perforated boards and printed circuit boards, with printed circuit boards being the preferred means of connection. The printed circuit board within the instrument 1400, which is made of standard commercial material such as FR4, and contains the microcontroller and its ancillary components including a stable oscillator, one or more analog-to-digital converters, a programmable clock, optional DC-DC converters, switches and various components including resisters, capacitors, inductors, switches and connectors, an opto-electrical measurement system, an optional wireless transceiver, connections to the power source, control buttons, display, and active components in the optical sub-system including the light source and light detector, and other modern components.

This module 1402 contains a wide variety of components and wiring (typically on a printed circuit board) that will route all power and signals appropriately. The power originates from the batteries 1401. It generally goes to a DC-DC converter on the PCB, which can take in a variety of voltages (for example, as the battery output voltage sags during its lifetime) and put out one or more constant voltages to power the various electronic components. Some of the power goes to a driver device that provides the voltage and current needed to power the excitation source. Power also goes to a microcontroller on the PCB, which serves as the brains of the analyzer for control, data acquisition, data analysis and concentration display functions. The microcontroller has on-board analog-to-digital converters (ADC) that accept analog signals from the fluorescence light detector 104 and turn them into digital data. A built-in clock is provided that time stamps all actions of the system. The electrical module also contains a temperature sensor, which is preferably digital (connected to a digital input port on the controller) but can be analog in nature (and connected to an ADC port on the controller). The electrical module must have connectors for power and signals from the batteries, to the light source, from the detector, from the control buttons and to the display, plus connectors for loading the program into the microcontroller and debugging the software performance.

The electrical module 1402 can employ diverse means of storing data, for example, memory in the microcontroller and SD or other flash memory cards. Different means of communicating data to a computer are also included. The linkage will commonly be a USB cable. But, the system can optionally have a wireless radio sub-module for transmission of the status of the electronics and battery and also analytical results to a computer near (within about 10 to 30 meters of the analyzer) for storage, manipulation, display and communication of information from the analyzer. Various wireless protocols (such as ZigBee, Bluetooth or Wi-Fi) might be use for wireless data transmission.

A program for a commercial microcontroller on the printed circuit board 1402, including a code for self-testing of the instrument, a means to set the clock time, stored calibration data, which controller can initiate and conduct optical, or optical and electrical measurements, use the calibration data to convert voltage or other signals into concentrations (such as milligrams per deci-liter or molarity), store the derived concentrations, display the time-stamped concentrations on the instrument or, optionally, provide time-stamped concentrations to the wireless transceiver for transmission to a receiver integrated with a computer.

Means to download clock, calibration and other information to the controller on the printed circuit board 1402 by either wired means (typically, but not limited to USB) or wireless methods (such as Wi-Fi, BlueTooth or ZigBee), which is needed for operation of the instrument. A program for a personal or other computer with an attached wireless transceiver for reception of concentration information from the instrument 1400, which permits both (a) reception and storage of measured concentrations, (b) transmission of clock, calibration and other information to the instrument and (c) input to the hand-held instrument of patients identifications, such as names or numbers by manual, bar-code or RFID means.

The electrical module 1402 can also incorporate a Lock-In Amplifier if it is desired to improve the signal-to-noise ratio offered by the analyzer 1400. This unit effectively rejects background signals due to unwanted light entering the analyzer. It requires a separate set of components, which would be incorporated into the electronics module. The use of a lock-in amplifier requires modulation of the excitation light source, which also requires additional circuitry. Inclusion of the lock-in amplifier in this disclosure does not mandate its use, but covers a widely-used technology that can be made part of the instrument to improve its performance.

Power Module. Means of obtaining electrical power for the instrument 1400 including interior batteries, or power obtained from outside of the instrument by wired (such as USB) or wireless (notable radio-frequency) means, with batteries interior to the housing being the preferred power source. Hence, electrical power for the analyzer will be obtained from batteries 1401 placed within the system. The chemistry (alkaline, nickel-metal-hydrogen, or lithium, for example) of the batteries, the voltage of the batteries (1.5, 3, 5, 9, 12 volts, for example), the form factor of the batteries (AAA, AA, C or other) and the capacities (milliamp hours) are not constrained in principle. Types of batteries for the system 1400 can include either single-use or rechargeable units based on any chemistry, with rechargeable Nickel-Metal-Hydrogen or lithium ion batteries being preferred. The specific battery types, numbers, voltages, shapes and capacities will be chosen after the choice of all specific components are made. Then, the actual power consumption rate of the system is known, along with the desired battery life, which will be on the order of days to weeks.

Housing. The instrument 1400 is housed in a rectangular solid housing that is approximately 4 inches long, 2 inches wide and 1 inch thick, roughly the shape and size of a whiteboard eraser. The thin disposable sample holder 100, 1200, 1300 is inserted through an opening in the top of the instrument housing for the analysis. The housing can be made of plastics, metals or composite materials. Plastics formed by injection molding are the preferred embodiment. The housing for the instrument 1400 can be shaped in any manner to accommodate its interior components, with a rectangular solid shape having rounded edges being the preferred shape.

The size of the housing for the instrument 1400 is constrained by its ability to hold the interior components on the small end and by ergonomic utilitarian considerations on the large end, with a hand-held size about four by two by one inch being near optimum both functionally and practically.

The housing for the analyzer contains and supports the interior optical, electrical and power modules, and supports the exterior control button(s) and display, plus accepts the sample holder. The housing can vary widely in shape, thickness and the materials from which it is constructed. A rectangular shape, as already mentioned, is highly functional. However, there is also the possibility of using a more ergonomic shape, if the device will often be used in a hand-held fashion. The housing should be electrically conductive, either intrinsically or by use of an applied conductive coating, to exclude exterior electrical noise, notably 60 cycle hum from AC power lines and lights.

The desired conductivity can be achieved by either the use of a metal housing or a plastic that is made to be conductive by incorporation of graphite or other particles. The wall thickness of the housing must be enough to give it needed stiffness (on the order of 1/16^{th} of an inch) but not significantly thicker, which would increase weight and cost without improving function. The housing must have a removable lid on which the button(s) and display might be placed, if wires between those components and the electrical module are long enough to permit sufficient motion of the lid relative to the rest of the housing during battery emplacement or replacement. The button(s) and display might be mounted on the side of the housing so that leads between them and the electrical module can be shorter and unmovable. An antenna can be provided on the housing (not shown in FIGS. 14(a), (b)) for the analyzer system to exfiltrate information by wireless means to a nearby computer, display or other device.

Controls. The ability to turn power to the electrical and optical modules on and off, and to initiate the analytical functions after insertion of a holder, will be accomplished by one or more controls or buttons 1405 on the exterior of the housing. If one button is used, a sequence of depressions can be used to achieve various states and functions. If multiple buttons are used, one button can be for the system on-off function, one for initiation of an analysis and one for sequencing through data stored in the memory of the microcontroller within the analyzer.

Exterior manual push or other buttons for control of the instrument 1400 which will turn the power to the printed circuit board of embodiment 10 on or off, and initiate the automatic sequence of measurements including data acquisition and conversion, and display or transmission of concentration values, and also permit sequential viewing the concentrations and times of earlier measurements under the control of the push or other buttons. Optional manual keys on the instrument of 1400 permit input of alphanumeric data for patient identification.

Display. A visual display (using but not limited to LCD technology) on the exterior of the instrument 1400 for display of concentrations and time stamps obtained during the last or earlier measurements. The display 1406 can be of diverse technologies, such as liquid crystals. It presents alpha-numeric information sent to it from the controller. The state of the system, the results of control actions and the results of the latest or earlier analyses can be shown on the display. That is, an analyzer designed so that it goes through a self-test routine when it is powered on, can be programmed to display the results of that self test. The display can also exhibit the state of the system, for example, when it is ready for insertion of another sample in a holder. The display can also show the results of the last or earlier tests, giving the concentration of the analyte in molarity or alternative units.

The present invention includes means to insure that samples do not contaminate the interior of the instrument to avoid contamination from samples or other sources. The ability of the instrument to be decontaminated by disinfection or sterilization is relevant to this invention. There are two approaches to providing such decontamination in the interior of the instrument. The first is to flood the interior with ultraviolet radiation. This can be done with external ultraviolet sources, or by employing ultraviolet sources built into the instrument. The second approach to decontamination is to place the instrument in a closed chamber, which can be filled with any gas that kills pathogens and other bacteria.

There are many alternative components that can be employed in this disclosed instrument. We have employed specific components (an LED light source, an interference optical filter and an amplified photodiode) in the prototype instruments for testing their performance. However there are many other components, both optical and electrical, which can be used within the present invention. Some are listed in the following table.

TABLE

| Components | Alternatives |
|---|---|
| Housing | Plastic, metal or composites. |
| Light Source | LEDs, lasers, lamps, all without or with matched |
| | driver circuits |
| Filters | Simple absorbers, high and low pass materials, |
| | interference filters |
| Detectors | Solid-State Silicon and other semiconductor PN, PIN, |
| | or Avalanche Detectors, or Vacuum Photomultipliers, |
| | with or without integrated or associated |
| | amplifiers |
| Amplifiers | Operational or Instrumentation Amplifiers, Cascaded |
| | amplifiers, lock-in amplifiers |
| Batteries | Diverse chemistries, voltages, capacities, shapes |
| | and volumes |
| Voltage Managers | DC-DC converters, Resistive voltage dividers, |
| | Charge pumps |
| Holders | Thin and flat are preferred, but square or round |
| | could be used |
| ADC | Separate chip or preferably part of the microcontroller |
| Microcontroller | Any of many parts that have adequate ports and low |
| | current consumption |
| Transceiver | ZigBee, WiFi, Bluetooth or other protocols |
| Control Buttons | Any of many designs |
| Display | B&W or color, LCD or other technology |

The sample holders of this invention can be filled with solutions of known concentrations in order to determine the calibration curve relating concentrations to voltage signals. Similarly, the use of solutions of known concentrations will permit checks on the performance of the instrument.

Alternative arrangements of this instrument are possible within the spirit and scope of the invention, and enable additional types of measurements. There are three primary approaches to optical measurements, the measurement of light absorption, light scattering or the measurement of stimulated fluorescence. All approaches require light sources, filters and detectors. The present invention can be employed to measure all three types of optical interactions. The arrangement shown in FIGS. 14(a), (b), 15(a), (b) and 16 are appropriate to measurement of fluorescence by use of a filter tuned to the wavelength of the fluorescent radiation. The same arrangement can be used to measured scattered light if the filter is passes only the wavelength of light emitted by the light source. If absorption measurements are desired, then the instrument has to have a detector in line with the source and sample. With the sample in place, the intensity of the unabsorbed radiation can be measured after a filter tuned to the wavelength of the incident radiation. With the sample and holder removed, the intensity of the radiation incident on them can be measured. The two intensities can be used to measure the percent absorption by the sample of the light incident upon it from the source.

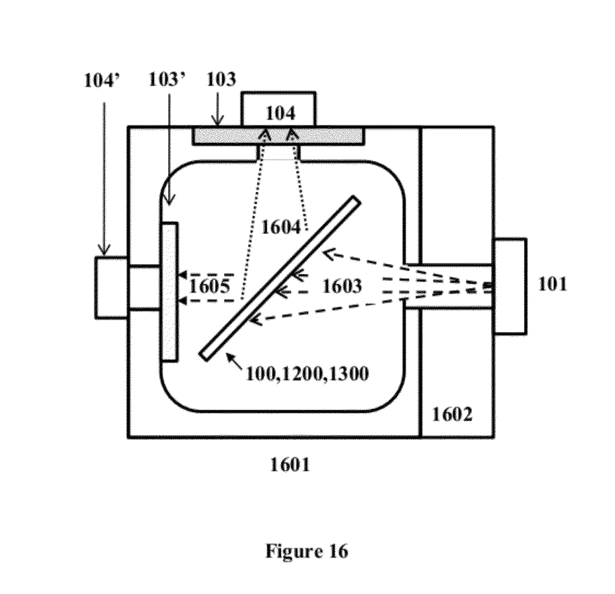

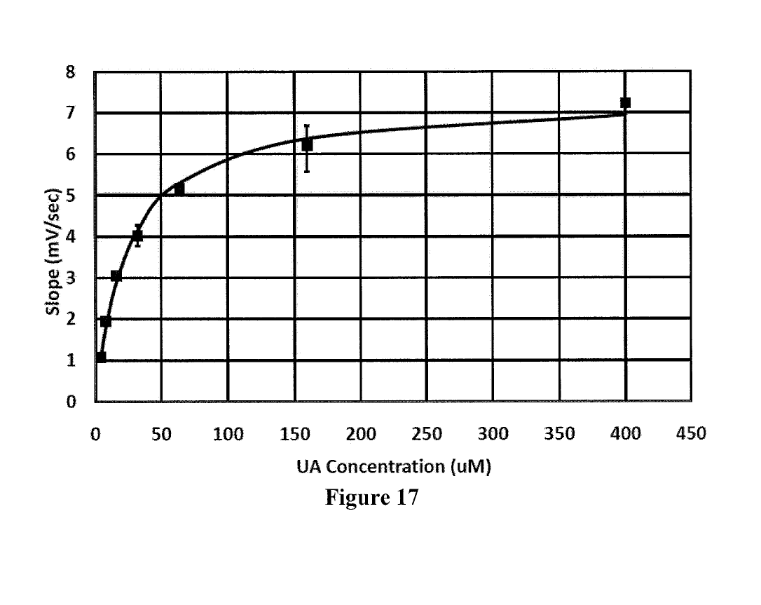

Turning to FIG. 16, a compact optical module, essentially a laboratory prototype of the core of the instrument shown in FIGS. 14(a), (b), were used to make fluorescence measurements. FIG. 16 shows a schematic cross section of the laboratory prototype instrument used to obtain the data shown in FIGS. 17-20.

The instrument has a structural housing 1601 made of black delrin plastic, a black delrin plastic block 1602 with a hole that serves to limit the light transiting from the excitation light source to the sample. Light that is not incident on the sample can be scattered about within the instrument. Some of it will make it to the detector and produce a background that reduces the analytical performance of the instrument. The use of alternative black surfaces, either other plastics or coatings, such as paint, inside of the cavity of the instrument, will also reduce scattered light. It is also possible to place thin materials within the cavity on some or all of its surfaces, which absorb light effectively, black velvet being one example.

Different analytes can be quantified by using different optical techniques within the instrument 1400 and 1600. The excitation radiation 1603 and the fluorescent or scattered radiation 1604 are also shown for the use of the instrument for analyses that depend on either fluorescence or scattering. It is also possible to use the prototype 1600 for absorption measurements, as indicated by the transmitted radiation 1605.

In the case of the measurement of scattered light, the light 1604 will be light from source 101 that is scattered by the sample, rather than fluorescent radiation. In this second employment of the analytical instrument, the filter 103 will pass only the wavelength of the source 101. If it is desired to measure the absorption of the light from the source 101 in the sample, then a hole collinear with the source and sample will be used to measure the transmitted intensity or the intensity without a sample in place. FIG. 16 shows the location of the filter 103′ and detector 104′ for absorption measurements using the analyzer. In this case, as for scattered radiation, the filter 103′ would pass the wavelength of the light from source 101 to the repositioned detector or a second detector 104′.

FIG. 17 presents data showing the rate of change of the fluorescent signal intensity from the amplified detector as a function of concentration of prepared uric acid samples. The dashed line is a fit to the data based on the Michaelis-Menten equation for enzyme kinetics. The equation of that line is also shown. The goodness of the fit proves that the kinetics of the reaction that leads to quantification of uric acid are well behaved.

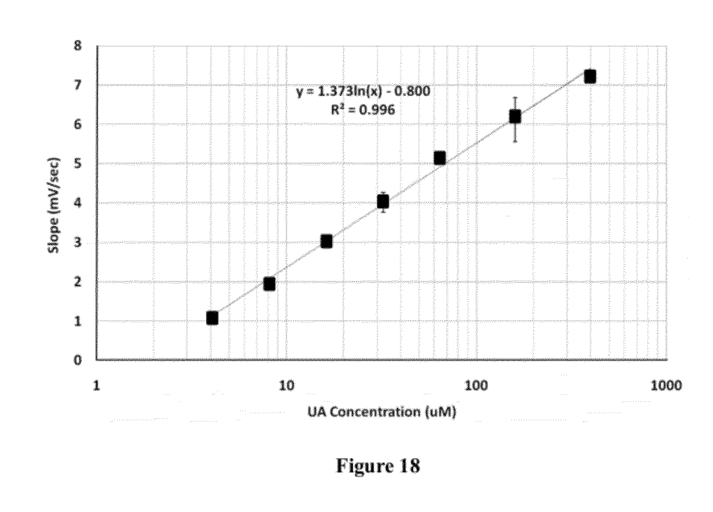

FIG. 18 gives the data from FIG. 17 plotted on a log-linear scale to serve as the calibration curve for analysis of uric acid in transparent samples such as saliva and urine. This calibration curve is well behaved, being linear on the log-linear plot, with small scatter in the data points from which it was made.

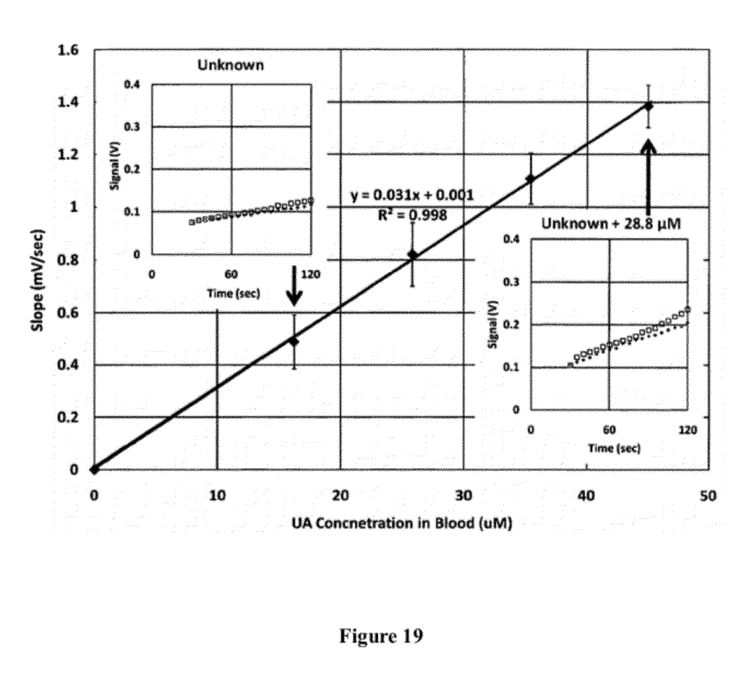

FIG. 19 shows the calibration curve for blood diluted with a buffer solution to make it transparent to both the excitation and fluorescent radiation. The initial concentration of the blood sample was not known, so this curve was obtained by spiking the blood sample with known levels of uric acid solution and also using the (0, 0) point. The insets show for two concentrations the rate of intensity increase as a function of time, from which the slopes were plotted to make the calibration curve. Here again, the quality of the calibration curve for blood is very high. This promises very good precision for the use of the combination of the sample holder and the instrument.

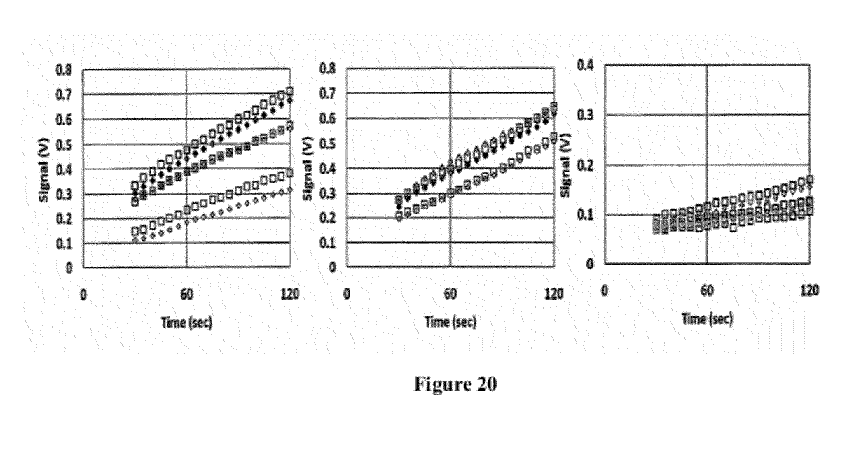

FIG. 20 presents the time histories of clinical samples of saliva (left, diluted 2 to 1), urine (center, diluted 100 to 1) and blood (diluted 20 to 1) from three study participants, with two measurements for each combination of sample and participant.

The use of this invention requires sample holders 100, 1200, 1300 that are compatible with the analyzer 1400. A primary advantage of those holders is that they contain all chemicals needed to produce needed reactions and obtain a fluorescent signal. There is no need for ancillary chemicals or apparatus for pre-treatment of a sample. Further, the holders draw in samples by capillary action, which does not require any liquid or pneumatic pumps. The holders will be relatively low in cost. This is a key advantage since disposable holders are necessary for clinical analyses. Hence, the instrument costing several hundred dollars will be reusable and the holders, with costs on the order of approximately $10, will be disposable.

Samples, such as blood, saliva and urine, can be placed into a holder, which can then be immediately inserted into this analyzer. Quantitative information on the molecule of interest, for example, uric acid, can be obtained on times on the order of one minute after insertion of the loaded sample holder into the analyzer. Total time from availability of the sample, through its loading into the holder to having results is on the order of two minutes.

The invention can be used immediately for laboratory research and for clinical studies by trained medical personnel. It can be further employed by medical personnel in doctor's offices, clinics and hospitals, and eventually by patients in their homes. There are few limitations on the locations where the invention can be used because it is small, battery powered and easily portable.

The present invention has a number of advantages, including that it is compact, of a size well matched to the handling of diverse samples, neither too large nor small. The instrument can be used on a table or other surface, or else hand-held in a building, vehicle, the field or other location. There are many alternative designs for the optical, electronic and mechanical aspects of the instrument. It can be used without ancillary optical components, such as lenses or mirrors. The performance of the instrument is well matched to the requirements for the analysis of clinical and other samples, with adequately low noise and good signals.

The instrument will cost substantially less than current desktop analyzers for performing the same analyses. The instrument can be used for analysis of a variety of target molecules, if there are enzymes or other recognition molecules available to pick them out in unseparated samples. Relatively untrained personnel can use this instrument, given its simplicity. Analyses can be obtained in a few minutes, with no need to send samples to a central laboratory with all the accounting and reporting that entails.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A micro-fluidic sample holder comprising:
a top plate;
a bottom plate; and
a retention element positioned between said top plate and said bottom plate and retaining at least one chemical, said retention element configured to receive a sample and combine the at least one chemical with the received sample.

2. The holder of claim 1, wherein said top plate and said bottom plate are transparent and are configured to receive excitation photons.

3. The holder of claim 1, wherein said holder is configured to be received in an analyzer instrument and wherein properties of the received sample can be obtained by optical fluorescence, absorption, scattering or chemiluminescence measurements, or electrical voltammetry, amperometery, coulometry or conductance measurements.

4. The holder of claim 1, wherein said top plate and said bottom plate are made of glass or plastic.

5. The holder of claim 1, wherein said top plate and said bottom plate are each flat and have substantially parallel top and bottom surfaces, and said top plate is substantially parallel to the bottom plate.

6. The holder of claim 1, wherein said top plate is smaller than the bottom plate to form a ledge on said bottom plate, the ledge configured to receive the sample.

7. The holder of claim 6, wherein said top plate entirely overlaps said bottom plate.

8. The holder of claim 1, wherein each of said top and bottom plates have an outer perimeter and a substantial amount of the outer perimeter of said top plate is aligned with a substantial amount of the outer perimeter of said bottom plate.

9. The holder of claim 8, wherein said top and bottom plates are rectangular, and two sides of said top plate are substantially aligned with two sides of said bottom plate.

10. The holder of claim 1, further comprising a fixation element for holding said top plate at a fixed position with respect to said bottom plate.

11. The holder of claim 10, wherein the fixed position comprises the top plate being separate and apart from said bottom plate.

12. The holder of claim 10, wherein said fixation element comprises an adhesive material adhered to said top and bottom plates.

13. The holder of claim 12, wherein said fixation element further comprises a spacer for maintaining said top and bottom plates at a predetermined distance from each other.

14. The holder of claim 1, wherein said top plate and said bottom plate are substantially the same size and said top plate has a through-hole configured to receive the sample.

15. The holder of claim 1, wherein said bottom plate has a first well configured to receive a first chemical and a second well configured to receive a second chemical.

16. The holder of claim 15, further comprising a first channel in said bottom channel, said first channel extending between said first well and said second well.

17. The holder of claim 16, wherein said bottom plate further has a third well configured to receive the received sample, and a second channel extending from said third well to said first well to transfer the received sample to said third well.

18. The holder of claim 17, further comprising a barrier located in said first channel to prevent movement of the first and second chemicals between said first and second wells.

19. The holder of claim 18, wherein one of said top and bottom plates has a flexible portion, whereby depression of the flexible portion forces the sample and the first chemical in said first well into said first channel to overcome said barrier and enter said second well.

20. The holder of claim 19, further comprising an air vent in communication with said second well, said air vent configured to permit air to vent outside said holder.

21. The holder of claim 19, wherein said first chemical comprises a diluent and said second chemical comprises a reagent.

22. The holder of claim 1, wherein said retention element comprises a substantially planar mesh material and has fibers defining an area in which the second chemical resides, wherein said fibers are configured to be uniformly covered with the second chemical.

23. The holder of claim 1, wherein said retention element comprises a mesh material having a coating to promote the desired reactions between reagents near the mesh and the sample.

24. The holder of claim 1, wherein said retention element comprises a pattern on an inner surface of said top plate and/or said bottom plate, wherein said chemical bonds to said patterned inner surface, and wherein a portion of said patterned inner surface has a hydrophobic material that prevents the chemical from bonding to said patterned inner surface.

25. The holder of claim 26, wherein a portion of said patterned inner surface has a hydrophyllic material that bonds with the chemical.

26. The holder of claim 1, wherein the sample is uric acid and the chemical includes enzymes, Uricase, Horseradish Peroxidase, and the precursor Amplex Red of the fluorescent reporter molecule Resourifin.

27. The holder of claim 1, further comprising at least two electrodes configured to be in contact with the received sample for electrical measurement of a concentration of a molecule of interest.

28. The holder of claim 1, wherein enzymes and Amplex Red are preloaded on said retention element prior to the specimen being received.

29. The holder of claim 30, wherein a water soluble polymer holds the enzymes and Amplex Red or other transduction precursor.

30. The holder of claim 31, wherein the water soluble polymer comprises polyvinyl alcohol and the enzymes and Amplex Red react with the specimen to form a fluorescent material.

31. The holder of claim 1, wherein said retention element comprises either a mesh material or a hydrophyllic coating.

32. An instrument for analyzing a sample, the instrument comprising:
a holder configured to retain the sample;
an excitation light source configured to pass light to the sample in the holder, whereby the sample generates, scatters and/or absorbs the light;
a filter configured to filter the light that has been generated, scattered and/or absorbed by the sample; and
a detector which converts the filtered light into a detected signal.

33. The instrument of claim 32, further comprising a controller for controlling the excitation light source and detector.

34. The instrument of claim 33, wherein said controller is configured to determine a property of the detected signal and further comprising a display device configured to display the determined property.

35. The instrument of claim 32, wherein said detector comprises an amplified detector which amplifies the detected signal.

36. The instrument of claim 32, wherein said instrument quantitatively determines a quantity of one of more specific molecules in blood, saliva, urine and other fluids.

37. The instrument of claim 32, wherein said detector comprises at least one photon detector configured for quantitative measurement of the intensity of the fluorescent light from the samples, wherein said photon detector comprises amplified photodiodes, avalanche photodiodes or photo-multiplier tubes.

38. The instrument of claim 32, wherein said instrument determines properties of the received sample obtained by optical fluorescence, absorption, scattering or chemiluminescence measurements, or electrical voltammetry, amperometery, coulometry or conductance measurements.

39. The instrument of claim 32, wherein said detector comprises a first detector and a second detector and said filter comprises a first filter aligned with said first detector and a second filter aligned with said first or second detector, and wherein said first filter passes wavelengths of fluorescent radiation to said first detector and said second filter passes the wavelength of the source for scattering to the first detector and for absorption/transmission to said second detector.
